(19) United States
(12) Patent Application Publication
(10) Pub. No.: US 2024/0171657 A1
(43) Pub. Date: May 23, 2024

(54) DIGITAL EDGE SERVICES ORCHESTRATION OF AWARENESS, ON-DEMAND, AND EVENT-TRIGGERED SERVICES

(71) Applicant: Intel Corporation, Santa Clara, CA (US)

(72) Inventors: Vesh Raj Sharma Banjade, Portland, OR (US); Kathiravetpillai Sivanesan, Portland, OR (US); Hassnaa Moustafa, San Jose, CA (US); Suman A. Sehra, Folsom, CA (US); Satish Chandra Jha, Portland, OR (US); Arvind Merwaday, Beaverton, OR (US); S M Iftekharul Alam, Hillsboro, OR (US); Francesc Guim Bernat, Barcelona (ES); Rajesh Poornachandran, Portland, OR (US); Xin Zhang, Shanghai (CN); Rony Ferzli, Chandler, AZ (US); Leonardo Gomes Baltar, Muenchen (DE)

(21) Appl. No.: 18/283,706

(22) PCT Filed: Jun. 25, 2021
(86) PCT No.: PCT/CN2021/102360

§ 371 Date: Sep. 22, 2023

(51) Int. Cl. H04L 67/61; H04L 67/12; H04W 24/02

(52) U.S. Cl. CPC H04L 67/61; H04W 24/02; H04L 67/12

(57) ABSTRACT

A computing node in an edge computing network includes a network interface card (NIC), memory storing a plurality of digital object representations of a corresponding plurality of participating entities, and processing circuitry. The processing circuitry detects a message from a participating entity of the plurality. The message is received via the NIC and is associated with a messaging service of the edge computing network. The message is mapped to a service class of a plurality of available service classes based on a service request associated with the message. The message is processed to extract one or more characteristics of the service request. A digital object representation of the plurality of digital object representations is updated based on the one or more characteristics of the service request, the digital object representation corresponding to the participating entity.

### TECHNICAL FIELD

Embodiments described herein generally relate to digital edge services in intelligent transportation systems, and in particular, to digital edge services orchestration of awareness, on-demand, and event-triggered services.

### BACKGROUND

With the proliferation of connected road infrastructure in smart city roads, smart intersections, and smart factories, telecommunications providers and/or Infrastructure Owner Operators (IOOs) continue to deploy network/road infrastructures that expand to Road-Side-Units (RSUs) at scale. However, existing service request discovery and quality of service (QoS) configuration techniques may be inadequate to enable scalable deployment and commercial wide-scale services on roads with the help of the edge infrastructure.

### BRIEF DESCRIPTION OF THE DRAWINGS

Some embodiments are illustrated by way of example, and not limitation, in the figures of the accompanying drawings in which:

FIG. 1 illustrates an RSU/small cell-based edge infrastructure deployed in a smart intersection, according to an example embodiment;

FIG. 2 illustrates a proposed functional edge stack architecture showing coexistence of edge services, digital representation services, and communication services for supporting heterogeneous messaging requirements within an edge infrastructure, according to an example embodiment;

FIG. 3 illustrates protocols and messaging system architecture for digital edge services orchestration with QoS provisioning for supporting multiple service classes, according to an example embodiment;

FIG. 4 illustrates a swimlane diagram of an awareness service (AS) communication exchange between an edge infrastructure and a participating entity (or actor), according to an example embodiment;

FIG. 5 illustrates a swimlane diagram of an on-demand service (ODS) communication exchange between an edge infrastructure and a participating entity (or actor), according to an example embodiment;

FIG. 6 illustrates a swimlane diagram of an event-triggered service (ETS) communication exchange between an edge infrastructure and a participating entity (or actor), according to an example embodiment;

FIG. 7 illustrates a diagram of a dimensionality reduction principle for joint dimension reduction based allocation of messaging services and edge services to actors in an edge infrastructure, according to an example embodiment;

FIG. 8 illustrates an example architecture using an accelerated activation function, according to an example embodiment;

FIG. 9 illustrates a diagram of an example communication flow associated with using an accelerated activation function, according to an example embodiment;

FIG. 10 illustrates an example communication exchange between road infrastructure and vehicles for automatic awareness of on-demand services, according to an example embodiment;

FIG. 11 illustrates an example communication exchange between road infrastructure and vehicles for distributed and real-time authentication, according to an example embodiment;

FIG. 12 illustrates an example communication exchange between road infrastructure and vehicles for on-demand subscription services, according to an example embodiment;

FIG. 13 illustrates an example communication exchange between road infrastructure and vehicles for global and real-time knowledge on vehicles, according to an example embodiment;

FIG. 14 illustrates a connected mobility ecosystem, according to an example embodiment;

FIG. 15 and FIG. 16 illustrates trend and evolution of in-vehicle platform architectures, according to an example embodiment;

FIG. 17 illustrates a mobile edge cluster at the in-vehicle platform, according to an example embodiment;

FIG. 18 illustrates a mutual authentication exchange between a mobile edge cluster at the in-vehicle platform and an edge infrastructure, according to an example embodiment;

FIG. 19 illustrates a cloud approach for microservice provisioning between a mobile edge cluster at the in-vehicle platform and an edge infrastructure, according to an example embodiment;

FIG. 20 is a flowchart illustrating a method for processing messages associated with a messaging service of an edge computing network, according to an example embodiment; and

FIG. 21 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

With the advent of Internet-of-Things (IoT) and Fifth Generation (5G) and 5G+ technologies, diverse classes and flows of data arriving at the edge from a variety of devices in smart cities, factories, commercial infrastructure, homes, and other verticals necessitate the processing of such large-scale data for analytics, visualization, prediction, and other services. Such analytics-based outcomes may then be fed back to the sources of the data in the real world, in real-time to result in the edge-to-real-world feedback control loop. For instance, connected cars or autonomous cars send humongous amounts of compute-intensive data (perception from sensors, speeds, locations, etc.) to be processed at the edge for, say, analytics in a smart city environment for potential hazards, source-to-destination best route prediction, and/or optimization and so forth. To this end, several challenges exist for edge computing infrastructure deployed within the smart city IoT scope, which can be addressed using the disclosed techniques: (a) Dynamic traffic or weather pattern prediction (e.g., including pedestrian behavior prediction, road hazard prediction for road users based on past and present data; context-aware critical event recorder, such as accident or collision, for scene or traffic incident management from the digital road-environment model); (b) Secure, real-time connected vehicle route planning services, traffic map generation, prediction and updating taking actual city topology into account with crowd-sourced data pose unique challenges for meeting the target QoS at edge infrastructure; and (c) Event-driven processing of unpredictable/undesired emergent behavior in (complex systems) service request/response model.

The disclosed techniques may be used to enable scalable deployment and commercial wide-scale services on roads with the help of edge infrastructure, perform the following functions: (a) provide edge services that are digitally aware (e.g., by using Digital Twin or DT technology in short) of its surrounding context, actors, object and environment, and at the same time maintain such up-to-date digital awareness jointly in a periodic (less time critical), on-demand (near-real-time) and in a critical event-triggered (urgent) manner; (b) the surrounding environment entities/actors such as people, vehicles and others in the vicinity of an edge infrastructure become aware of the edge infrastructure service offerings respectively for periodic, on-demand, and event-triggered services; (c) the edge infrastructure handles provisioning of different QoS targets associated with such periodic, non-periodic (due to on-demand from service subscribers), and event-triggered (due to environmental incidents) service requests with appropriate responses; (d) configure format of data, content, and protocol needed for real-time exchange of data between the infrastructure edge server and the actors/devices in its surrounding in aspects when the edge infrastructure offers co-training/learning/inferencing offloading services for real-time inferencing (especially to actors/devices with lower computation capabilities in real-time); and (e) enable multiple edge servers distributed in space locally or across different geo-areas be aware of each other's digital environments to continually offer service handovers (of non-stationary/moving subscribers or on-demand requesters) between multiple edge infrastructures distributed in space locally or in across larger geo-areas.

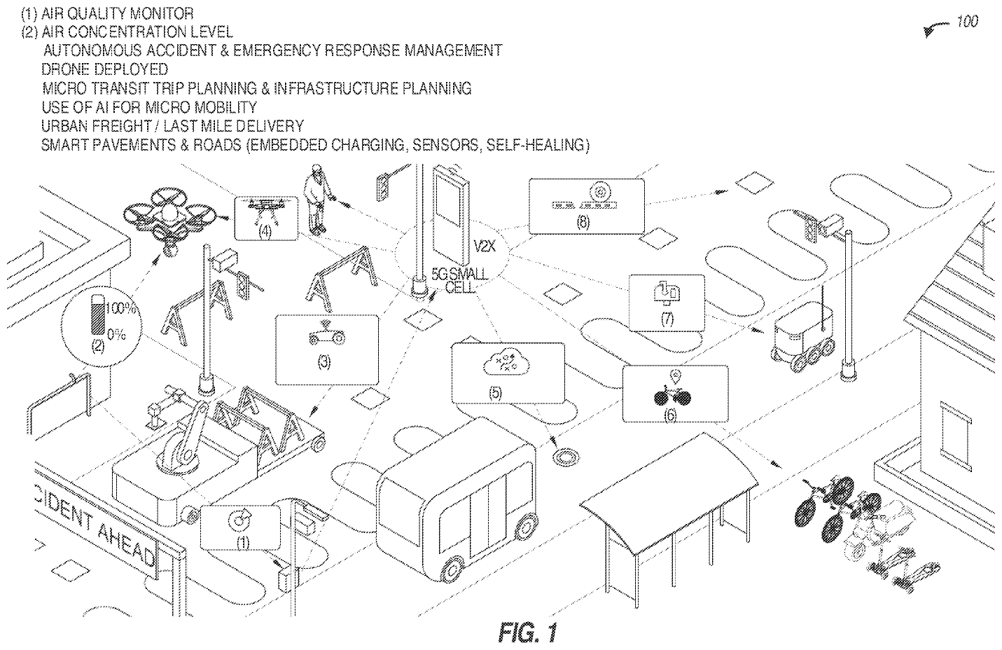

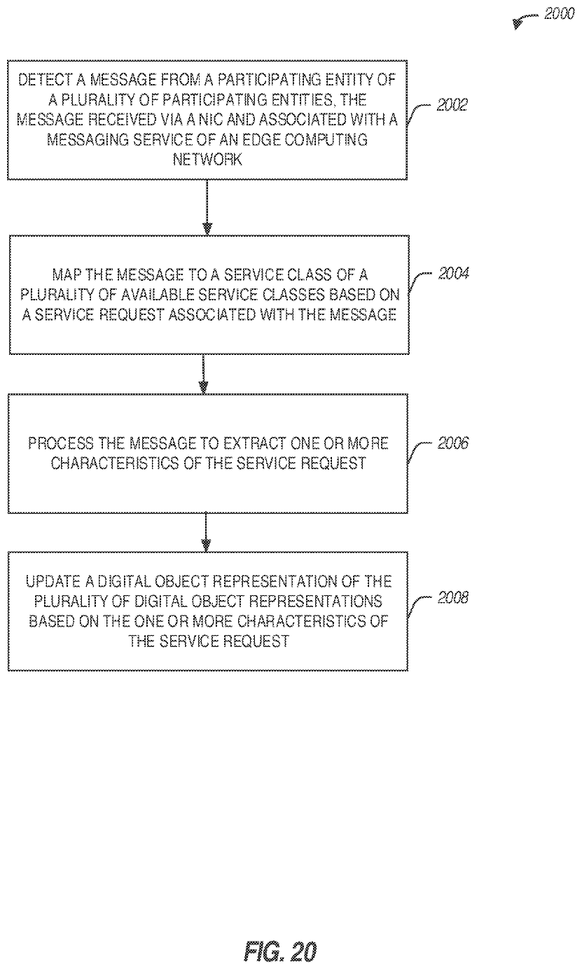

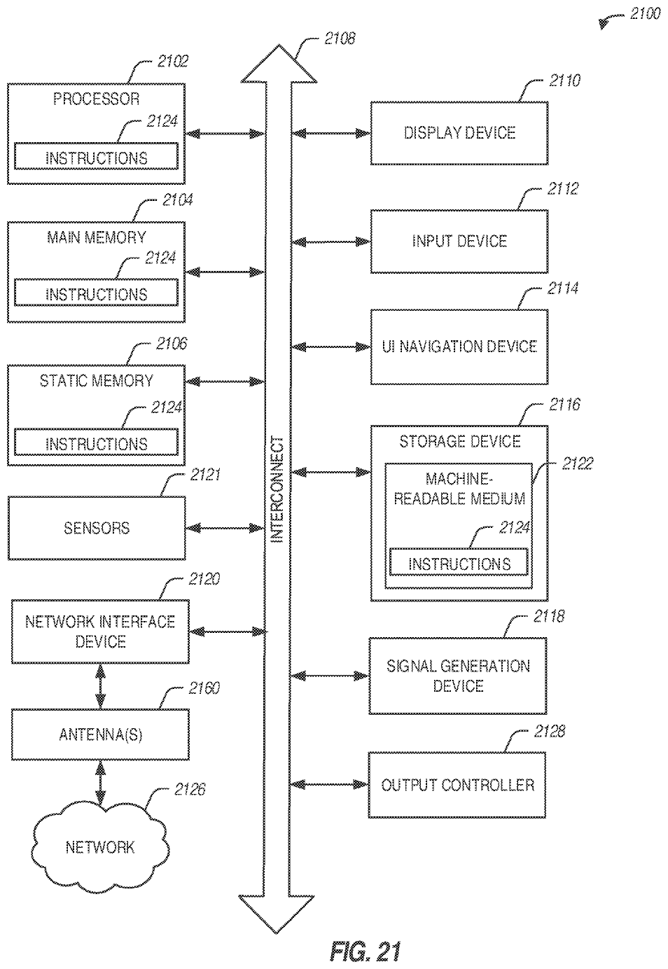

More specifically, the disclosed techniques (e.g., as discussed in connection with FIG. 1-FIG. 13, FIG. 20, and FIG. 21) provide a functional system architecture of the infrastructure edge stack for enabling coexistence of the edge services, digital representation services, and communication services for supporting heterogeneous messaging requirements within the edge infrastructure full-stack. The disclosed techniques further provide protocols for digital edge services orchestration and awareness with support for arbitrary L number of service classes with QoS provisioning, exemplified via Awareness Service (AS), On-Demand Service (ODS), and Event-Triggered Service (ETS). The disclosed techniques further provide functionalities where transactions from crowd-sourced agents, RSU, edge infrastructure, etc., can be captured in a public distributed ledger anonymously for provenance, reputation, revocation, loyalty, etc., with audit trails that can be queried/searched. In some embodiments, downlink (DL) analytics can be applied on top of a blockchain towards self-learning and adaptation without manual/central agent involvement. Furthermore, the disclosed techniques use a bi-directional negotiable interface between participating entities towards dynamic service level agreement (SLA) renegotiation with a micropayment-based reward system towards efficient RSU management.

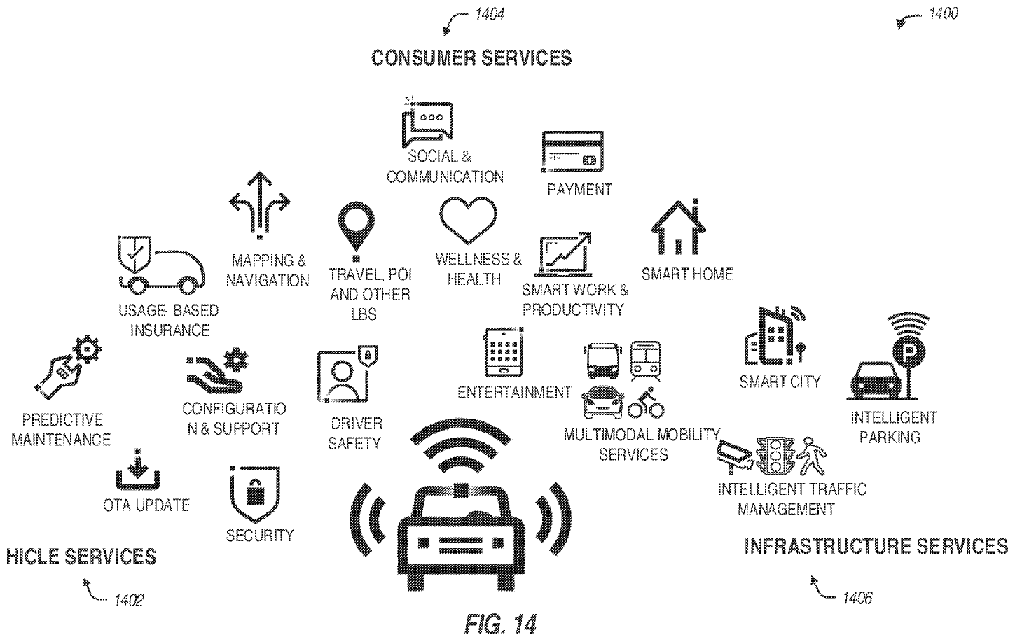

The disclosed techniques (e.g., as discussed in connection with FIG. 14-FIG. 19 and FIG. 21) further include in-vehicle cloud-native open platform. More specifically, to accelerate application development for the in-vehicle platforms, the disclosed techniques may be used for expanding cloud-native orchestration frameworks to handle mobile edge nodes (the in-vehicle platform). The disclosed techniques are associated with a mobile node configured with a Kubernetes or other container deployment cluster and allow the opportunity for streamlining the in-vehicle platform(s) application on-boarding through an interoperable approach.

FIG. 1 illustrates an RSU/small cell-based edge infrastructure 100 deployed in a smart intersection, according to an example embodiment. Existing or new potential users of edge computing services may not necessarily be aware of the service offerings of, e.g., a smart RSU-based edge infrastructure 100 deployed in a smart city intersection. Furthermore, some of the already existing subscribers of the edge services, on one hand, could be generating on-demand requests (e.g. bike ride reservations or taxi reservation requests). On the other hand, critical event-driven requests may be automatically generated due to the occurrence of emergency incidents or events in the edge infrastructure 100 (e.g., accidents). Depending upon the reason and context for the generation of the edge services, QoS requirements can range from non-critical to time-critical. Moreover, time-critical offerings need to coexist with the periodic services that the edge infrastructure offers.

In the communication scenario illustrated in FIG. 1, an initial digital representation (or equivalently, a digital twin representation) of the local environment can be available at the edge infrastructure 100 represented as an RSU deployed at a smart intersection. As used herein, the term “digital twin” indicates that all the actors in the edge infrastructure 100 (such as pedestrians, vehicles, moving objects, stationary objects, animals, and other network-connected or non-connected entities, collectively referred to as participating entities) have a corresponding digital model representation available at the RSU (or one or more other network nodes such as a base station or a network management node which is also referred to as an orchestrator node). Such model, for instance, can be built from continuous data acquired via advanced sensor capabilities at the RSU ranging from high depth/field cameras, light detection and ranging (LIDAR) devices, radio detection and ranging (RADAR) devices, and others. For the rest of the disclosure, the initial digital model representation creation and availability at the RSU (or the management node) is assumed as completed or can be completed as an initial functionality that is part of the disclosed functionalities.

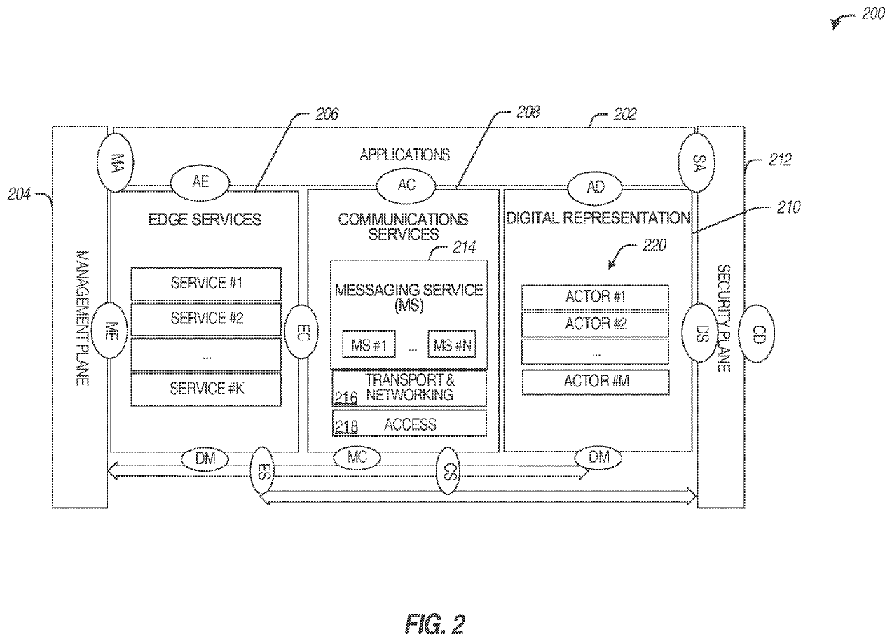

FIG. 2 illustrates a proposed functional edge stack architecture 200 showing the coexistence of edge services, digital representation services, and communication services for supporting heterogeneous messaging requirements within an edge infrastructure, according to an example embodiment. Referring to FIG. 2, the functional edge stack architecture 200 includes an application layer 202, a management plane 204, edge services layer 206, communications services layer 208, digital representation layer 210 of participating entities (or actors) 220, and a security plane 212. The communications services layer 208 further includes a messaging service (MS) layer 214, transport and networking functions layer 216, and access functions layer 218.

In some aspects, the disclosed techniques may be associated with the edge services layer 206, the communications services layer 208, the digital representation layer 210, which are discussed in greater detail herein below.

The edge services layer 206 includes value-added services (e.g., service 1, . . . , K in FIG. 2) offered by the functional edge stack architecture 200. The edge services layer 206 includes multiple interfaces, namely, interfaces to the application layer 202, the management plane 204, and the communications services layer 208, and the security plane 212 as denoted by AE, ME, EC, and ES, respectively (where the letters in the 2-letter notations represent the first letter of the corresponding layer name). A similar naming convention is used for the remaining interfaces. As evident from FIG. 2, the edge services layer 206 supports a total of K services, a service instance denoted as Sₖ with k=(1,2, . . . , K), which may be denoted by the vector E_{S} as shown below:

E_{S}={S₁,S₂, . . . ,S_{K}} (1)

The communications services layer 214 is used for handling heterogeneous messaging requirements. Due to diversity in the sensors at the infrastructure as well as varying granularity of requirement in the representation of the digital environment context (for example, rich in detail data capturing (e.g. a stream of raw images, LIDAR point clouds) and sharing versus analytics capturing and sharing) the size of the data/analytics could range in the order of few GBs to hundreds of GBs. Thus, the disclosed techniques to handle diverse message types in the edge infrastructure's communication layer. For example, in ETSI Intelligent Transportation System, at least five different types of Facilities layer messages exist for different context/content sharing across available within the road environment such as Cooperative Awareness Message (CAM), Vulnerable Road User (VRU) Awareness Message (VAM), Collective Perception Message (CPM), Maneuver Coordination Message (MCM), Decentralized Environmental Notification Message (DENM) along with corresponding services to support such messages. Moreover, additional MS s may be supported and the proposed techniques may apply to any arbitrary number N of messaging services (regardless of whether those are standardized or proprietary). As seen in FIG. 2, the MS layer 214 can support N MSs, MSₙ with n={1,2, . . . , N}, which we denote by the vector M_{S} as follows:

M_{S}={MS₁,MS₂, . . . ,MS_{N}} (2)

The disclosed techniques are associated with the following three types of service protocols discussed herein below: (a) an Awareness Service (AS) protocol; (b) an On-Demand Service (ODS) protocol; and (c) an Event-Triggered Service (ETS) protocol. However, the disclosed techniques may also apply to any number L of service classes.

In some embodiments, the digital representation layer 210 includes digital representations of actors 220 in the surrounding road environment. As used herein, the term “actors” in a smart city/smart transportation domain indicate to be any entity ranging from pedestrians, animals, drones, emergency responder equipment, construction equipment, light poles, traffic signs, Robotaxis, human-driven taxis, bicycles, and other possible entity on the road as depicted in FIG. 1. To this end, the digital representation (or digital twin) of the actors at the infrastructure may consist of the accurate and consistent model of the environment at the edge infrastructure which essentially comprise of the actors' features represented by (but not limited to) the following information: position, velocity, class/type of the actor (e.g., a person, a pet, a child, a bicycle ride, a card, an object, and so forth), a unique ID, trajectory waypoints along with possible alternative trajectories for maneuvering (which can vary based on the actor's class/type), acceleration/deceleration information, etc.

In some embodiments, one or more of the features above are described in terms of model state, which can have varying representations ranging from traditional to artificial intelligence/machine learning (AI/ML)-based representations. For example, the position, velocity, and trajectory features can be characterized by using a neural network (NN) representation, whose parameters can be are trained and evolved continuously with historical, immediate past, or present data, and also require some form of predictive features for future time-series data generation.

As seen in FIG. 2, the digital representation layer 210 mainly encompasses such actors and can support, in general, M actors, Aₘ, with m={1,2, . . . , M}, which may be denoted by the vector A_{S} as follows:

A_{S}={A₁,A₂, . . . ,A_{M}} (2)

In some embodiments, the focus of the disclosed techniques may be not on how to represent such actors but on what kind of information exchange and flow/protocol is needed to update and maintain such representation as well as how to orchestrate/schedule the edge services given the diverse MSs types for the actors (where such large number of such digital representations may need to be maintained corresponding to a large number of actors at the edge infrastructure).

In some embodiments, the digital representation for some actors may be expanded beyond model-based representations. For example, in the case of an autonomous driving (AD) vehicle, a certain software stack is running on the vehicle. If such software stack is available and the edge infrastructure has adequate computing power, an AD emulation can be run which will take real sensor data as inputs, and outputs expected action/behavior. This processing may be useful when the AD software stack gets updated and may be checked if the stack is producing expected behavior in the real-world setting.

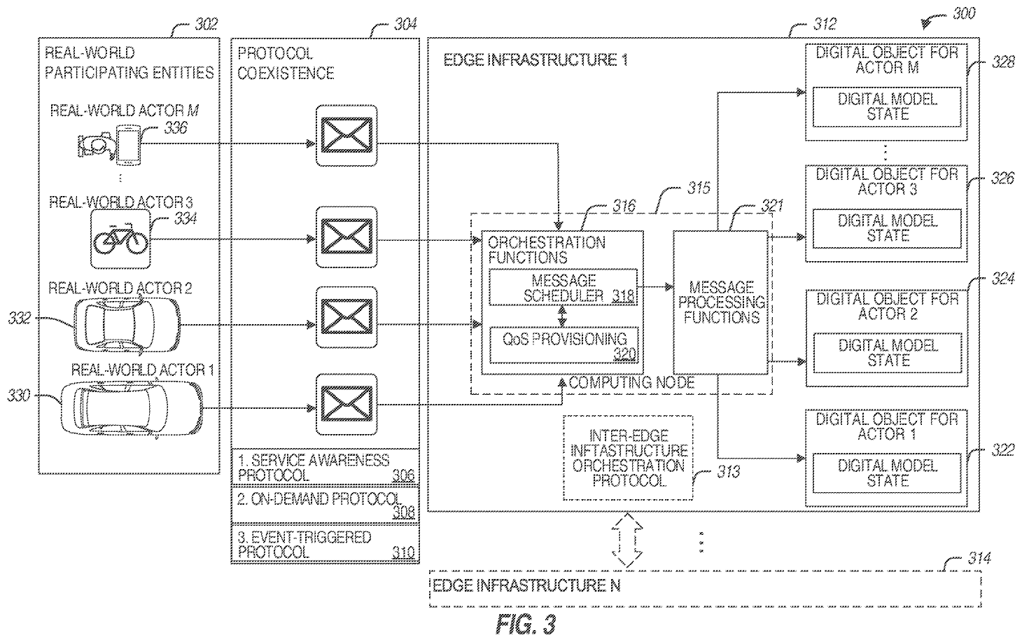

FIG. 3 illustrates a messaging system architecture 300 for digital edge services orchestration with QoS provisioning for supporting multiple service classes, according to an example embodiment. Referring to FIG. 3, the messaging system architecture 300 includes participating entities 302, a protocol coexistence layer 304, and N edge infrastructures 312, . . . , 314. The participating entities (or actors) 302 associated with the edge infrastructures include M participating entities 330, 332, 334, . . . , 336. The M participating entities (which can be participating entities illustrated in FIG. 1) are configured to communicate with edge infrastructure 312, which is configured to provide orchestration functions 316 and message processing functions 321. The message processing functions are associated with digital object representations (also referred to as digital objects or digital twins) 322, 324, 326, . . . , 328 of corresponding participating entities 330, 332, 334, . . . , 336. Each of the digital object representations may include a digital model state associated with a state of the corresponding participating entity.

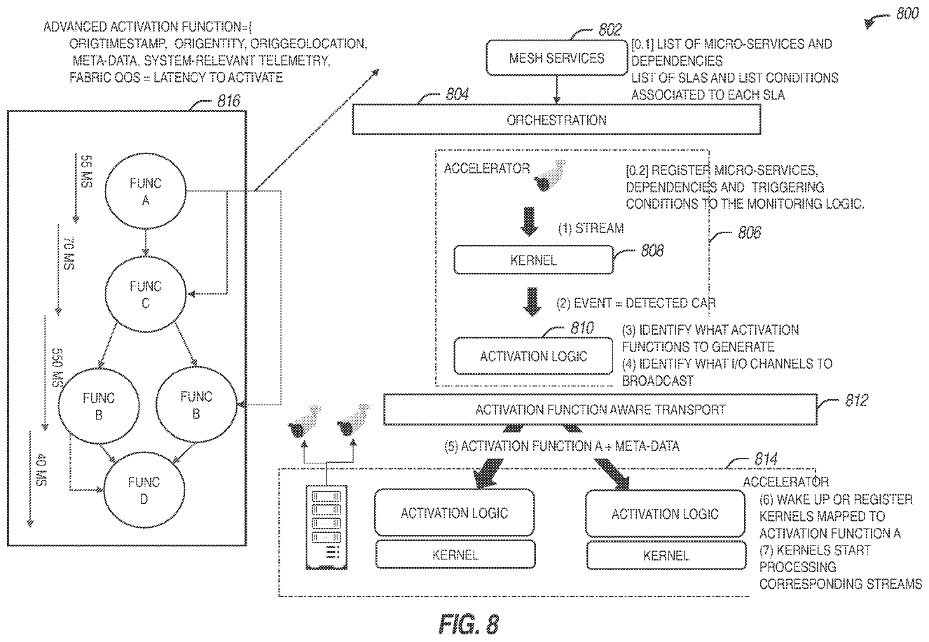

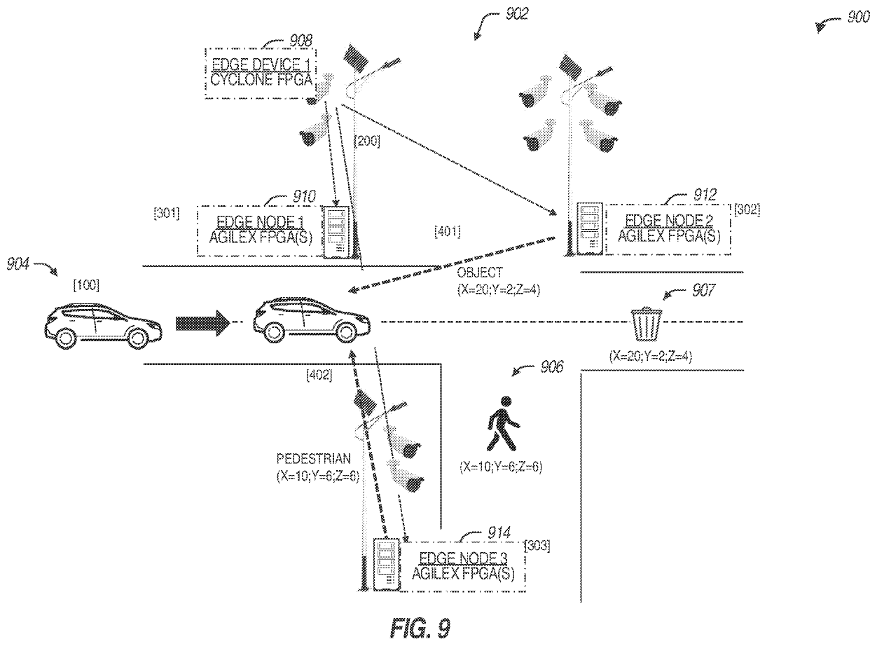

In some embodiments, the orchestration functions 316 include message scheduler functions 318 and QoS provisioning functions 320. In some embodiment, the orchestration functions 316 and the message processing functions 321 may be configured and performed by a computing node 315 within the edge infrastructure 312. In some embodiments, the computing node 315 may be a network management entity such as an orchestrator. In other embodiments, the computing node 315 may be implemented as a different type of network entity such as a base station, on RSU, or in a vehicle (e.g., as part of the in-vehicle cloud-native open platform discussed in connection with FIG. 14-FIG. 19). In some embodiments, the computing node 315 may include one or more accelerators (e.g., as accelerator hardware) to perform acceleration functions (e.g., as discussed in connection with FIG. 8 and FIG. 9).

The edge infrastructure 312 further includes inter-edge infrastructure orchestration protocol 313 for communication with other edge infrastructures such as edge infrastructure 314.

The protocol coexistence layer 304 includes functionalities associated with the following types of protocols (with corresponding supported service classes) depending on QoS requirements: a service awareness protocol 306 to support Awareness Service (AS) Class, an on-demand protocol 308 to support On-Demand Service (ODS) Class, and an event-triggered protocol 310 to support Event-Triggered Service (ETS) Class. In some embodiments, functionalities of the protocol coexistence layer 304 can be implemented and performed by the computing node 315 in edge infrastructure 312.

Even though FIG. 3 specifies three different service types or classes, the disclosure is not limited in this regard and use of other types or classes is not precluded and can be covered via the techniques proposed herein. Moreover, orchestration functions 316 with arbitrary L number of service classes is discussed hereinbelow, which ratifies an extension of the disclosed techniques to arbitrary types of services addressable by the proposed protocols.

The sub-components within the edge infrastructure 312 for Actor Aₘ, where m={1,2, . . . , M} are as follows:
(a) Orchestration functions 316. This functional block is responsible for two tasks which include message scheduler functions 318 and QoS provisioning functions 320.

The input to the orchestration functions 316 is the diverse classes of messages coming from a variety of actors that need to be serviced per their QoS requirements and via the protocol coexistence layer 304. In some embodiments, various QoS service classes may be defined, and then the messages for all actors may be mapped within those classes to jointly schedule and guarantee the target QoS within the communications and compute resource constraints/limits. After mapping the incoming messages to one of the service classes (e.g., one of the set {AS class, ODS class, ETS class}), the priority of scheduling for the ETS class is set to highest, the ODS class is set to second highest, while the AS class is third as evident from the urgency of servicing the message represented as follows:

Priority(AS class)<Priority(ODS class)<Priority(ETS class) (3)

In some embodiments, the orchestration functions 316 may be used for getting the incoming message ready for processing. The detailed algorithm for message processing is discussed hereinbelow and illustrated in Table 1, which includes further details regarding priority/rank-based QoS provisioning and scheduling.
(b) Message processing functions 321. Following the orchestration phase associated with the orchestration functions 316, the message processing functions 321 may include de-parsing, extraction of features, and meta-data associated with the physical objects, followed by passing on to the corresponding digital object representation of the physical object (or actor).
(c) Digital object representations 322, . . . , 328. The digital object representations for each actor may be updated based on the de-parsed data. Depending upon the protocol type, the rate of update of the digital model state may be different as determined by the scheduling phase. For instance, for ETS, the model state update would naturally happen in an event-triggered fashion, while for ODS it may happen in an incremental and/or persistent fashion depending upon the arriving on-demand message traffic/rate. Lastly, for AS, the update would happen periodically with the configured rate of the AS message (e.g., every few seconds).

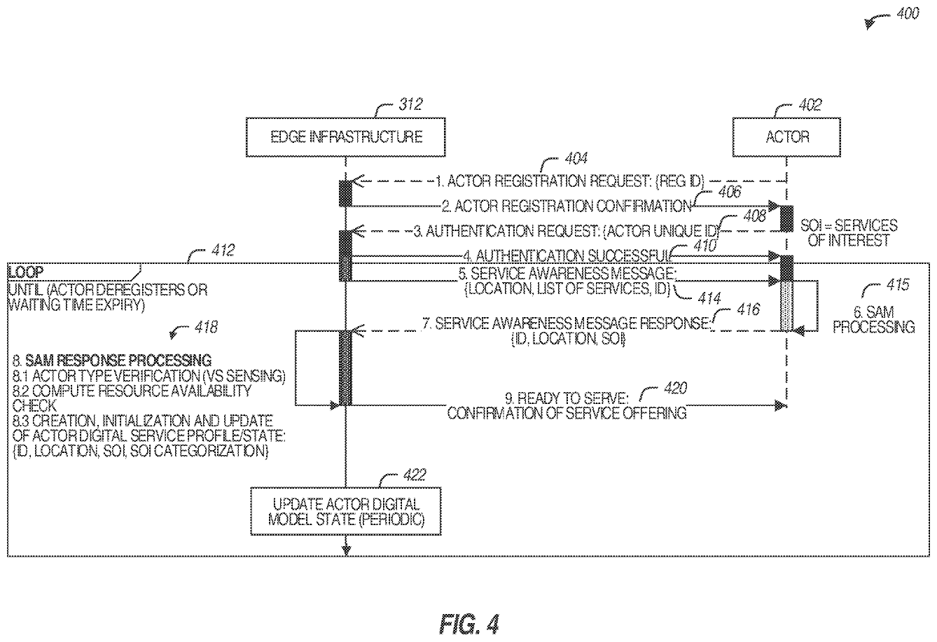

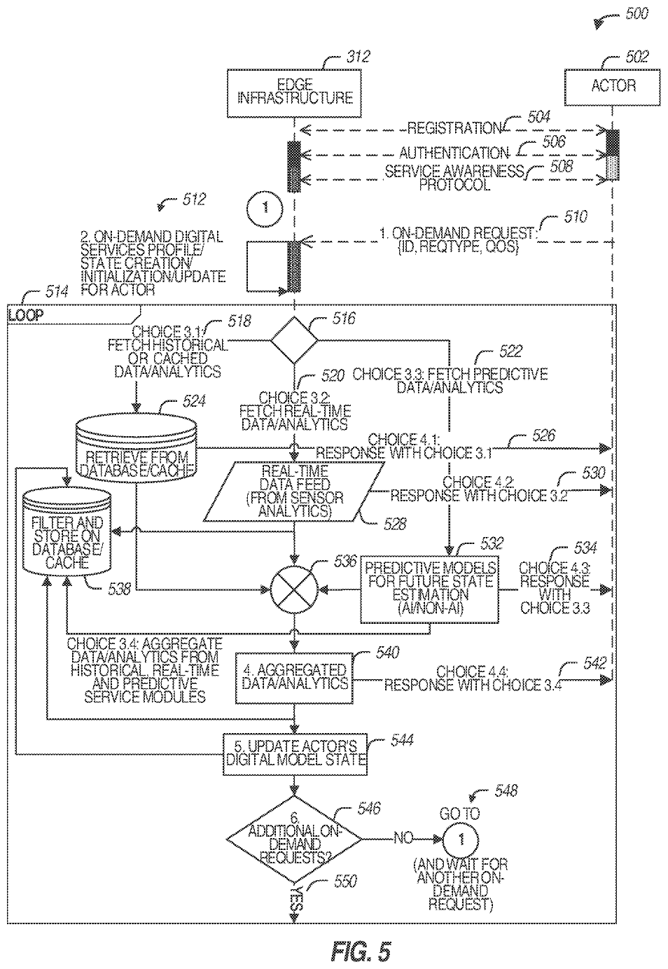

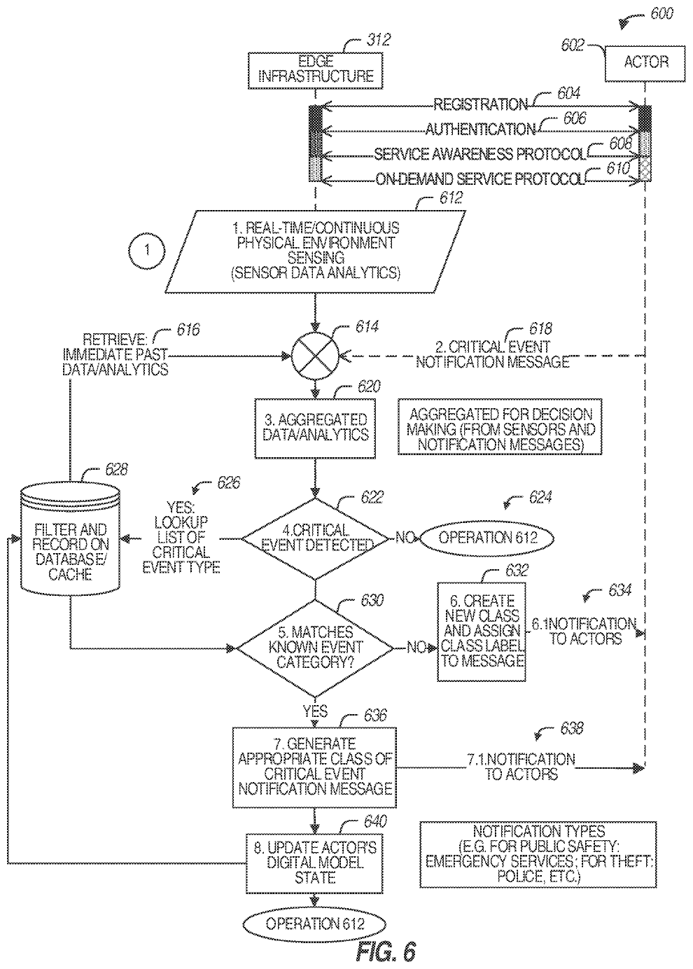

Example communication flows associated with each of the three protocols are illustrated in connection with FIG. 4, FIG. 5, and FIG. 6.

FIG. 4 illustrates a swimlane diagram of an awareness service (AS) communication exchange 400 between the edge infrastructure 312 (e.g., the computing node 315) and a participating entity (or actor) 402, according to an example embodiment.

Referring to FIG. 4, at operation 404, actor 402 communicates an actor registration request with a registration ID. At operation 406, the computing node 315 communicates an actor registration confirmation back to actor 402. At operation 408, actor 402 communicates an authentication request with the actor's unique ID. At operation 410, the computing node 315 responds with an “authentication successful” indication to actor 402.

Subsequent operations may be performed within a processing loop 412. More specifically, at operation 414, computing node 315 communicates a service awareness message (SAM) indicating, for example, the location of the node, list of services, and node ID. Actor 402 performs SAM processing (at operation 415), and at operation 416, communicates SAM response with the node ID, the actor location, and services of interest (SOI) selected from the list of services. At operation 418, computing node 315 performs SAM response processing, which includes actor type verification, compute resource availability check, creation, and initialization. At operation 420, computing node 315 communicates a “ready to serve” message with a confirmation of the service offering. At operation 422, computing node 315 updates the actor's digital object representation (e.g., updates the digital model state with the ID, location, SOI, and SOI categorization).

In this regard, after the service awareness messaging phase, the edge infrastructure is aware of the actor's presence and SOI, while the actor is aware of the edge infrastructure and its offered services. In some embodiments, the service awareness messaging is configured as a periodic procedure. Additionally, the actor's digital representation/twin model may be updated at the infrastructure periodically, regardless of whether it generates on-demand or event-triggered request(s).

FIG. 5 illustrates a swimlane diagram of an on-demand service (ODS) communication exchange 500 between the edge infrastructure 312 (e.g., the computing node 315) and a participating entity (or actor) 502, according to an example embodiment. Referring to FIG. 5, at operation 504, actor 502 communicates an actor registration request with a registration ID. At operation 506, an authentication procedure takes place between the computing node 315 and actor 502. At operation 508, service awareness protocol communication may take place (e.g., as discussed in connection with FIG. 4).

At operation 510, an on-demand request is communicated by actor 502 to computing node 315. The on-demand request includes the actor ID, request type, and QoS requirements. At operation 512, computing node 315 performs on-demand creation/initialization/update of the digital model state for the digital object representation of the actor.

Subsequent operations may be performed within a processing loop 514. At an initial decision 516, computing node 315 may perform operation 518, operation 520, or operation 522.

At operation 518, historical or cached data/analytics information is fetched or retrieved from database 524 and a corresponding response is provided at operation 526. At operation 520, computing node 315 fetches real-time data or analytics information using real-time data feed 528 (e.g., from sensor analytics), and a corresponding response is provided at operation 530.

At operation 522, computing node 315 fetches predictive data or analytics information using predictive models 532 for future state estimation (which can be AI or non-AI-based). The corresponding response is provided at operation 534. The real-time data and the predictive model data may be stored in database 538.

The computing node 315 may further use aggregation module 536 to aggregate data or analytics information at operation 540 and provide a corresponding response at operation 542. At operation 544, the actor's digital model state in the corresponding digital object representation is updated. At operation 546, a determination is made on whether additional on-demand requests are received by the computing node 315. If no additional on-demand requests have been received, at operation 548, processing resumes with the computing node waiting for another on-demand request. If additional on-demand requests are received, at operation 550, loop 514 may resume at operation 516.

FIG. 6 illustrates a swimlane diagram of an event-triggered service (ETS) communication exchange 600 between an edge infrastructure 312 (e.g., the computing node 315) and a participating entity (or actor) 602, according to an example embodiment. Referring to FIG. 6, at operation 604, actor 602 communicates an actor registration request with a registration ID. At operation 606, an authentication procedure takes place between the computing node 315 and actor 602. At operation 608, service awareness protocol communication may take place (e.g., as discussed in connection with FIG. 4). At operation 610, on-demand service protocol communication may take place (e.g., as discussed in connection with FIG. 5).

At operation 612, real-time or continuous physical environment sensing is performed by the computing node 315 (e.g., using sensor data analytics). At operation 614, past data or analytics 616 retrieved from database 628 is aggregated with a critical event notification message 618 received from actor 602, to generate aggregated data/analytics 620. At operation 622, computing node 315 determines whether a critical event is detected based on the aggregated data/analytics. If a critical event is not detected, at operation 624, processing resumes at operation 612. If a critical event is detected, at operation 626, computing node 315 performs a lookup for a list of critical event types using database 628.

At operation 630, a determination is made on whether a known event category is matched. If there is no match, at operation 632, a new class is created and a class label is assigned to the received message. A corresponding notification is communicated to all actors at operation 634. If there is a match with a known event category, at operation 636, the appropriate class of critical event notification message is generated and communicated to all actors at operation 638. At operation 640, the digital model state in the actor's digital object representation is updated, and processing resumes at operation 612.

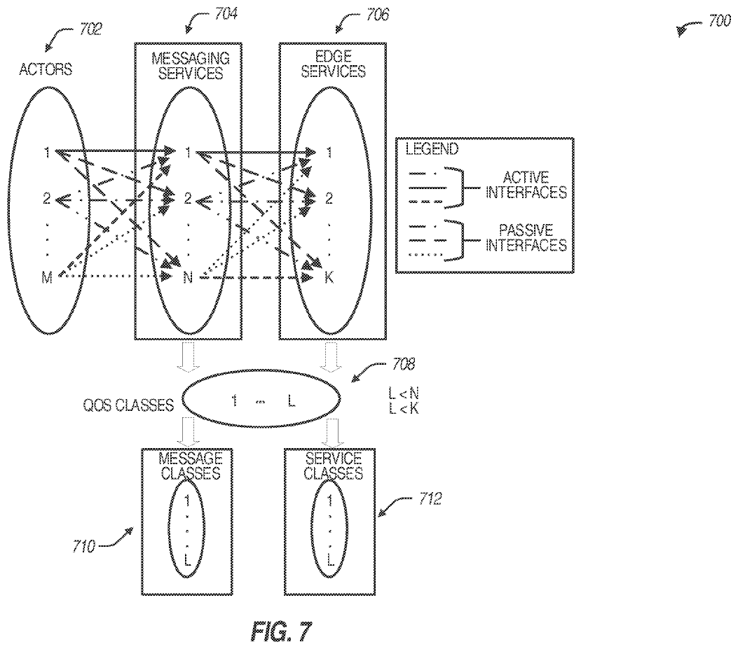

FIG. 7 illustrates diagram 700 of a dimensionality reduction principle for joint dimension reduction based allocation of messaging services and edge services to actors in an edge infrastructure, according to an example embodiment. The dimensionality reduction principle illustrated in FIG. 7, as well as the service orchestration algorithm with QoS provisioning (SOAQP) in Table 1, may be used for services orchestration functions including joint scheduling and QoS provisioning based on L service classes. More specifically, the edge infrastructure can include M actors 702, N messaging services 704, and K edge services 706, which are used to determine L QoS classes 708 (with L<K and L<N). The QoS classes 708 can be configured as L message classes 710 or L service classes 712.

TABLE 1
Algorithm 1: Service Orchestration Algorithm
with QoS Provisioning (SOAQP)

| Step | Procedure | |
|---|---|---|
| 0 | Define L QoS classes (QCs): {QoS₁, QoS₂, ... , QoS_{L}} where | |
| | each QoS class corresponds to a unique QoS requirement. | |
| 1 | For each Actor Aₘ, where, m = {1,2, ... , M}, | |
| 1 | For each Service request Sₖ, where, k = {1,2, ... , K}, | |
| 1.1 | | For each Messaging service MSₙ, where, n = |
| | | {1,2, ... , N}, |

| | |
|---|---|
| 1.1.1 | Create and Maintain a 3D Binary Services |
| | Record Matrix of dimension M × K × N denoted |
| | by ASM with M Rows, K Columns and N Layers |
| | with entries equal to TRUE if Actor Aᵢ has |
| | requested service Sⱼ for which messaging MSₙ |
| | must be triggered. Set the entries equals to |
| | FALSE otherwise. |
| 1.1.2 | For each column, discard the FALSE row and |
| | layer entries to come up with a reduced subset of |
| | ACTIVE service requests and messaging needs. |
| 1.1.3 | Map service requests according to QoS |
| | requirements onto one of the L service classes |
| | (SCs) where L is selected such that L < K. |
| 1.1.4 | Map messaging needs according to QoS |
| | requirements onto one of the L message classes |
| | (MCs) where L is selected such that L < N. |

| | |
|---|---|
| 2 | The output of Step 1: Matrix is a compressed version of ASM |
| | matrix of step 1.1.1 with M rows L columns and L Layers |
| | where L < K and L < N as shown in FIG. 7. Denote the |
| | compressed matrix by [symbol] . |
| 3 | Rank each QoS class L for assigning service order |
| | priority/importance in descending order: with the highest- |
| | ranked entry becoming the first to be serviced and with most |
| | communications and computing resource allocation and the |
| | subsequent lower-ranking entries to be serviced in the order of |
| | the rank, respectively. |
| 4 | Order each entry of [symbol] subject to rule 3 to schedule into the |
| | processing pipeline. |

In some embodiments, the algorithm provided in Table 1 may be performed by the computing node 315 and may be generalized to any L. However, for illustrative purposes and ease of explanation, the present disclosure uses L=3 QoS classes as an example for explaining the concept without any loss of generality. For L=3, the QoS classes may be set to {QoS_1,QoS_2,QoS_3} to correspond to the triple {Event Triggered Service (ETS), On-Demand Service (ODS) and Awareness Service (AS)}, respectively.

### Use of Accelerated Activation Functions

FIG. 8 illustrates an example architecture 800 using an accelerated activation function, according to an example embodiment. Referring to FIG. 8, architecture 800 includes mesh services 802, orchestration functions 804, accelerator 806 with an operating system kernel 808 and activation logic 810, activation function where transport 812, and peer accelerators 814. Additional configurations for the architecture 800 are illustrated in FIG. 8.

In some embodiments, conditional, real-time, low latency responses may be needed from connected network clients/nodes. The term “conditional” is used because often a response is required only when there is a specific action. For example, in FIG. 8, the drone could be taking surveillance footage. Under some circumstances, the camera on the drone detects some potential anomaly from overhead, or potentially identifies a wanted car from the license plate/color/make from overhead, but wants local street cameras to confirm before flagging an alarm. In this context, a mechanism may be used to have the platforms, accelerators, and edges automatically trigger events in other locations without requiring any software stack processing.

FIG. 8 describes the proposed techniques using accelerated activation functions such as activation function 816. In some aspects, each acceleration logic (e.g., accelerator 806) is expanded with a logic that relates events that the kernel 808 can generate based on the analytics that it is performing (such as vehicle speed above a certain threshold) to a set of activation functions that need to be triggered into a set of peer accelerators 814 (through any fabric) to start performing some type of processing. The goal is to abstract the services to the topology on how the events need to be propagated to the various accelerators. In some embodiments, the disclosed techniques cover how the activation functions are defined and integrated into the orchestration and transport layer.

FIG. 9 illustrates a diagram of an example communication flow 900 associated with using an accelerated activation function, according to an example embodiment. Referring to FIG. 9, the communication flow 900 is associated with vehicle 904 and pedestrian 906 being monitored at intersection 902.

Initially, the accelerator running on edge devices 908 (e.g., a camera) identifies that a car is going at speed X (e.g., operation [100] in FIG. 9). This event is communicated to the device inter-kernel logic. The inter-kernel logic has a rule that defines that when a car speed X is between A and B (e.g., A<X<B), it must generate an activation function to the accelerator in edge nodes 1, 2, and 3 (e.g., nodes 910, 912, and 914) to start road segmentation.

The accelerator of device 908 then sends the three activation functions (using an activation channel) to the accelerator on Edge Nodes 1, 2, and 3 (e.g., operation [200] in FIG. 9).

The accelerators in edge nodes 1, 2, and 3 automatically start performing road segmentation (e.g., operations [301], [302], [303] in FIG. 9). Accelerators in edge nodes 2 and 3 identify an object 907 and a pedestrian 906 in intersection 902. These accelerators may have rules, which define that both identified events have to generate activation functions. However, in this case, the activation functions are V2X communication to propagate the identified elements to vehicle 904 (now in a new position) (e.g., operations [401] and [402] in FIG. 9).

In the example of FIG. 9, activation functions for a specific type of use case are discussed. However, the disclosed techniques may be applied to any similar type of deployment model that may benefit from automatic propagation. On the other hand, the example in FIG. 9 illustrates that the final activation function is sent to the vehicle using C-V2X. However, other actions can be triggered as well using the disclosed techniques (such as to generate information down to the next levels of the edge).

### Example Solutions with Connected Autonomous Vehicles as Actors on the Road

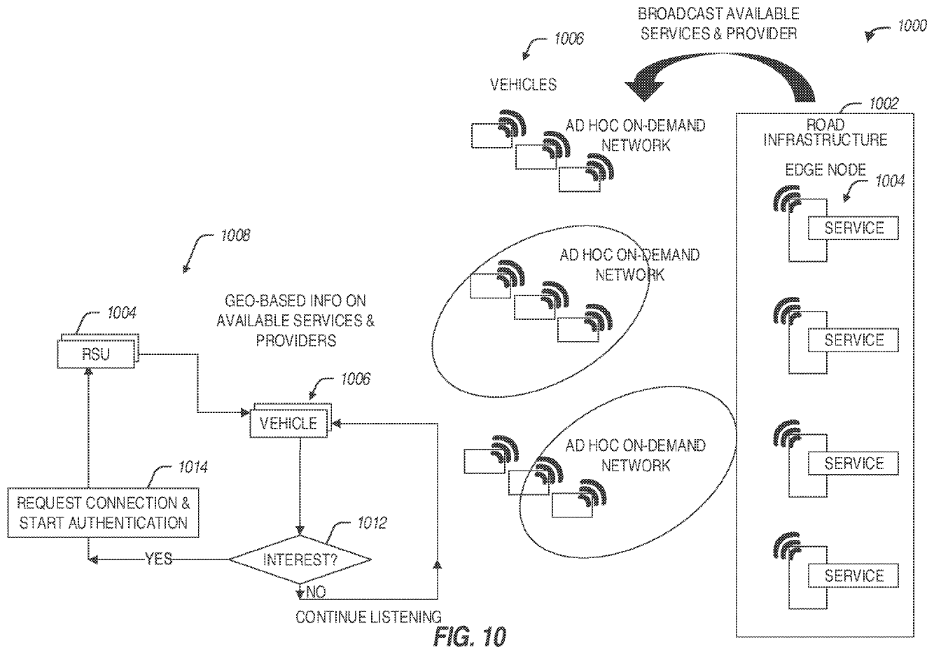

FIG. 10-FIG. 13 illustrates example solutions and use cases associated with the concept of connected vehicles (in a preconfigured manner), which may be used in connection with scalable deployments and wide-scale commercial services, with techniques for configuring smart architectures with learning “cause/effect” of decisions that are taken by vehicles and infrastructure.

FIG. 10 illustrates diagram 1000 of an example communication exchange between road infrastructure and vehicles for automatic awareness of on-demand services, according to an example embodiment. Referring to FIG. 10, road infrastructure 1002 includes a plurality of edge nodes 1004 which are in communication with vehicles 1006. In some aspects, edge nodes 1004 may include RSUs.

Each of the vehicle 1006 has a listener module (that can be part of a smart NIC or on-board unit) to learn about the RSUs 1004 per road segment, and the services that they offer. One example embodiment could be to leverage a wireless credential exchange functionality embedded with a vehicle platform for RF-based authentication between the vehicles 1006 and the RSUs 1004 with air-gapped security.

In some aspects, the listener module can be enabled or disabled on-demand. Processing functions are illustrated as flow diagram 1008 in FIG. 10. At operation 1012, a vehicle determines whether there is interest in subsequent communication with an RSU. If there is no interest, the vehicle continues listening. If there is interest, at operation 1014, the vehicle requests a connection with the RSU and starts an authentication process. In this regard, RSUs 1004 may broadcast available services and providers. Upon information on desired services, a vehicle requests a connection. Additional considerations may be taken into account by the vehicle when requesting a connection, including the availability of service roaming across providers.

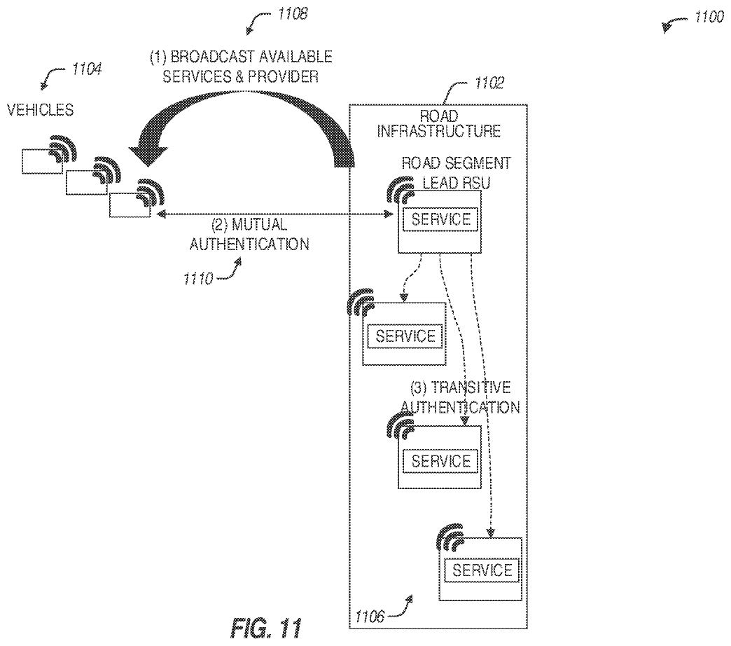

FIG. 11 illustrates an example communication exchange 1100 between road infrastructure 1102 and vehicles 1104 for distributed and real-time authentication, according to an example embodiment. Referring to FIG. 11, road infrastructure 1102 includes RSUs 1106.

In some embodiments, the road segment lead RSU shares information about the existing services across RSUs in each road segment (e.g., at operation 1108)

Each vehicle (of the vehicles 1104) traveling in the road segment requests authentication to the road segment lead RSU, if interested in the lead RSU announced services. Following the mutual authentication 1110 between the vehicle and the road segment lead RSU, the RSU initiates transitive authentication for the subject vehicle with the other RSUs belonging to the same road segment. In some embodiments, the authentication relies on real-time key generation for the road segment lifetime. In some embodiments, possible approaches to use may include a one-time password and root of trust between the vehicle and the provider.

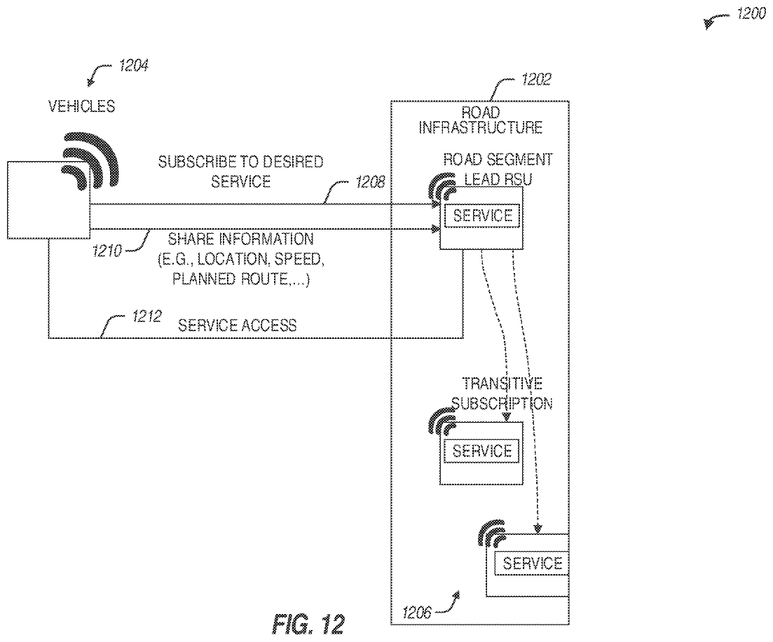

FIG. 12 illustrates an example communication exchange 1200 between a road infrastructure 1202 and vehicles 1204 for on-demand subscription services, according to an example embodiment. Referring to FIG. 12, road infrastructure 1202 may include multiple RSUs 1206, including a road segment lead RSU with a transitive subscription to services provided by other RSUs.

In some embodiments, following the vehicle and the road segment RSU authentication and services discovery, the vehicle subscribes to the desired service (at operation 1208). The vehicle selectively shares information (at operation 1210) (opted-in) based on the subscribed services required information. In some embodiments, information sharing is carried out for the duration of the service. In some embodiments, the road segment lead RSU performs transitive subscription for the subject vehicle with the RSUs belonging to the road segment. In some embodiments, the service coverage desired by the vehicle can be part of the shared information, which allows the road segment lead RSUs to determine the transitive subscription coverage and provide service access to the vehicle (e.g., at operation 1212).

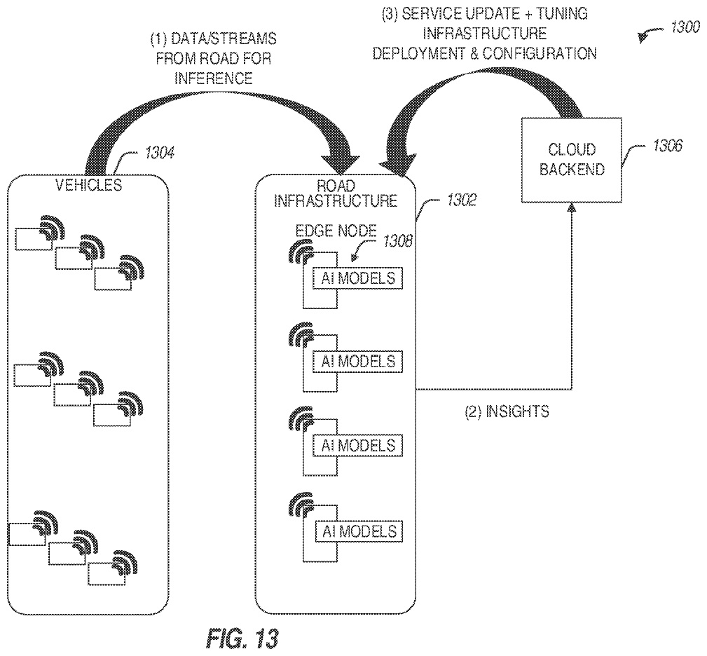

FIG. 13 illustrates an example communication exchange 1300 between road infrastructure 1302 and vehicles 1304 for global and real-time knowledge on vehicles, according to an example embodiment. Referring to FIG. 13, road infrastructure 1302 is in communication with Cloud backend 1306, and includes multiple edge nodes (e.g., RSUs) 1308, with each RSU using one or more AI models.

During an example learning stage, continuous statistics information (e.g., how many vehicles are connected to each RSU per day/time of day/road segment and in which geo-location) is communicated (e.g., as data/streams from the road for further inference). Additional information used during the learning stage includes categories of services and percentage of services consumption by which category of vehicles, services consumption percentage and vehicles reaction to a consumed service, and overall improvement of road safety, efficiency, and traffic flow through this infrastructure.

During an example prediction stage, infrastructure utilization per-geo-area, road segment, day of the week, time of day, and categories of vehicles may be generated. Additional information generated during the prediction stage includes service utilization and value-added to each vehicle consuming the service(s).

In some embodiments, based on autonomous vehicles route plan, the edge infrastructure can plan for the management of associated services with pre-reservation (e.g., towards emergency responders).

In some embodiments, the proposed protocol service architecture in FIG. 2 is associated with the following solution approaches and techniques:
(1) Design of the application layer (or middleware) messages exchange protocol between all the involved actors within the coverage of the edge computing servers (such as local environment objects, people, vehicles, and other entities).
(2) Support for periodic, on-demand, and event-triggered message protocols.
(3) Messaging protocol (message format, structure, and exchange protocol) with the following features:
(a) Periodic awareness/announcement/notification of available services. An approach where the edge will be advertising or broadcasting its offered-service-awareness via service-awareness-message (SAM) that serves as a cognition message of its offered services by nearby potential actors.
(b) Model-state networking (MoSN) for maintaining/updating digital virtual actors' models of people, things, contexts periodically and in real-time.
(c) Orchestration of periodic, on-demand, and event-triggered service requests: SAM, on-demand user input requests, and event-triggered response to environmental incidents (automatically generated by devices or infrastructure sensor detection based).
(d) Acquisition, update, and maintenance of digital service model (backend) needed for offering such periodic and on-demand (real-time) services at the edge computing servers. This functionality may be achieved within (i) Service Awareness Messaging, (ii) On-Demand Services (ODS), and (iii) Event-Triggered Services (ETS).
(e) Co-training/learning offloading service at the edge infrastructure for devices/actors with lower computation capability to support real-time inferencing at such lower computation capable devices/actors (for example, for lower-computation capability urban freight delivery vehicle shown in FIG. 1). Such co-training offloading service can further aid predictive services via real-time inferencing by acquiring global and real-time knowledge from the road actors periodically and continuously.
(4) Provisioning for heterogeneous services such as time-critical and non-time-critical QoS, including:
(a) Latency sensitive and latency insensitive, coverage of diverse QoS classes via priority provisioning mechanisms.
(b) Age of information and criticality of information consideration for service response (event-triggered vs user luxury request vs user emergency request) may be considered.
(c) Heterogeneous services for users via dynamic provisioning to dispatch new service functionalities as messages to create new data flow for agilely updating real-time or non-real-time services.
(5) Orchestration mechanisms across edge computing infrastructure to facilitate the following:
(a) Periodic, on-demand, and event-triggered services request subject to mobility where the actor(s) traverse multiple geo-areas served that may be served/managed by multiple edge server entities.
(b) After an actor or a subscriber ends the service with one infrastructure or must continue its services when moving on to an area served by next edge infrastructure, coordination or orchestration-based context transfer between the RSUs/edges may be used (e.g., as a Digital Environment Awareness model transfer).

### Additional Considerations and Aspects for the Disclosed Techniques

The disclosed techniques provide solutions for the open issues to enable scalable deployment and commercial wide-scale services on roads by an edge infrastructure. The following may be considered as distinguishing features from the current state-of-the-art:
(1) System architecture for edge infrastructure full stack including Digital Representation (Digital Twin) Layer, Heterogeneous Communications Layer, and Diverse Edge Services Layer along with service interfaces between them and the Management/Security planes.
(2) Mechanisms for edge infrastructure services awareness, maintenance, and updating based on the digital environment representation of the proximal environment containing all the involved actors (pedestrians, objects, vehicles, animals, and the like).
(3) Protocol for periodic and on-demand service offerings in an edge infrastructure together with support for diverse QoS classes and provisioning requirements.
(4) Messaging protocol for enablement of providing time-critical, time-non-critical (user-generated on-demand), and event-triggered services.
(5) Orchestration and digital awareness transfer, exchange, or handover protocol across services as well as multiple geo-distributed edge infrastructures. This may include global learning method at the edge infrastructure to learn the different decisions taken by the road-actors based on inputs from infrastructure, and how the AI/ML algorithms in the infrastructure and the sensing capabilities result in specific improvements on roads safety and effectiveness (e.g., accident avoidance, the effectiveness of weather alerts, traffic status).
(6) Selective/opted-in information sharing by actors (vehicles, pedestrians, and others) based on the subscribed services.
(7) Bi-directional negotiable interface between RSUs and actors (e.g. vehicles, pedestrians, and others) towards SLA negotiation based on provisioned policies.

### In-Vehicle Cloud-Native Open Platform

The connected mobility ecosystem is growing with the advancement in 5G and edge computing, and opening new business opportunities and business value chains for new actors (e.g., software (SW) providers, compute service providers, etc.). In this new ecosystem, a vehicle platform is an edge computing node (but mobile) connecting to services on-demand while on the road, and a cloud-native applications framework may be used in the vehicles allowing services/applications on-boarding on demand. However, there is no current solution/framework considering cloud-native applications on-boarding, updating, and orchestration in the vehicle. The disclosed in-vehicle open platform techniques may be used in connection with the techniques discussed above in connection with FIGS. 1-13 to enable on-demand services on-boarding in vehicles (e.g., as discussed in connection with example use cases in FIG. 10-FIG. 13) and align with a connected mobility ecosystem and orchestration solutions.

FIG. 14 provides an overview of the connected mobility ecosystem, which opens the opportunity to lease vehicle resources for a general compute. FIG. 14 illustrates a connected mobility ecosystem 1400, according to an example embodiment. More specifically, the ecosystem 1400 may include vehicle services 1402, consumer services 1404, and infrastructure services 1406.

Existing in-vehicle platforms are closed systems, not allowing wide developers and application providers access to the in-vehicle ecosystem. In some aspects, such access is limited to OEMs and Tier1/Tier2 entities to develop associated apps. Additionally, cloud-native application frameworks are limited to cloud platforms and fixed edge platforms. The existing closed system approach for the in-vehicle platforms constrains usage to limited actors and does not follow a cloud-native agile approach for applications on-boarding and update. Also, cloud-native application frameworks do not fit for a mobile edge node like the vehicle platforms.

The disclosed in-vehicle open platform techniques may be used to accelerate application development for the in-vehicle platforms, expanding cloud-native orchestration frameworks to handle the mobile edge node (the in-vehicle platform). The disclosed techniques bring the notion of a mobile node in a Kubernetes cluster and open the opportunity for streamlining the in-vehicle platform(s) application on-boarding through a standard and interoperable approach. Additional benefits of the disclosed techniques include the following: (a) deploying cloud-native clusters in the vehicles and expanding on the status-quo cloud-native frameworks that count on fixed clusters, opening the opportunity to lease vehicle resources for general compute; (b) offering an open platform for in-vehicle use, allowing agile cloud-native application development by many players instead of silo solutions existing today with closed platforms; and (c) bringing a container-based ecosystem for vehicles applications that accelerate building services and comply to open standards.

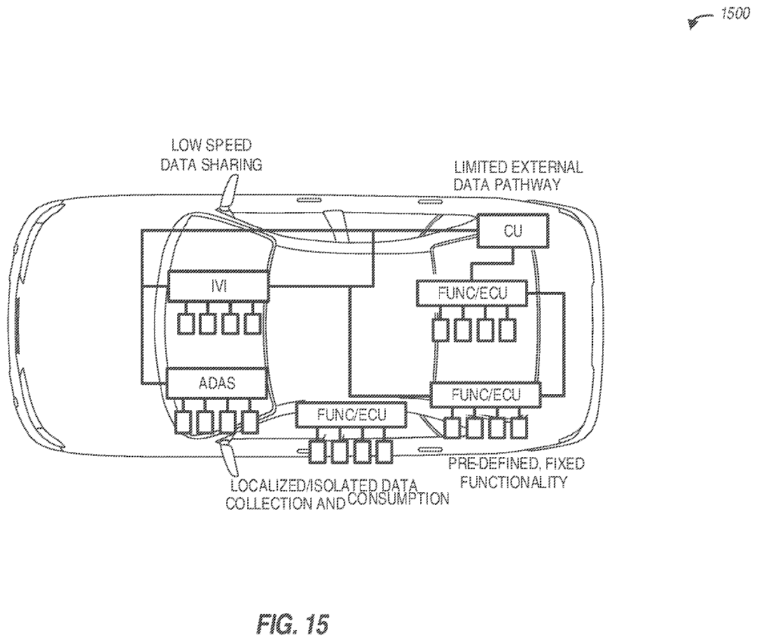

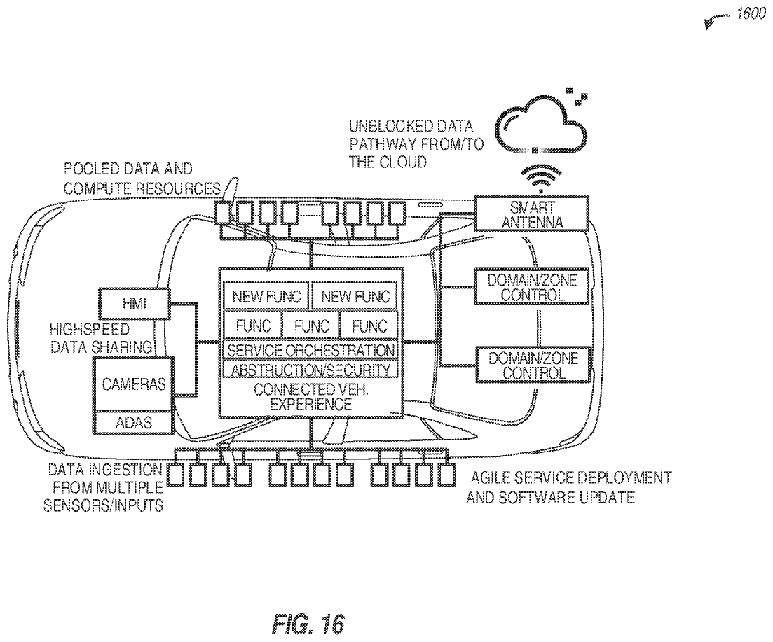

A parallel effort is taking place in terms of the in-vehicle platform's architecture, where disclosed aspects are facilitated by using software-defined cloud-native platforms. FIG. 15 and FIG. 16 provide an overview of this trend and evolution for in-vehicle platforms. FIG. 15 and FIG. 16 illustrates the trend and evolution of in-vehicle platform architectures, according to an example embodiment. FIG. 15 illustrates a diagram of vehicle 1500 associated with fixed function, distributed, the traditional approach for vehicle architectures, where inherent dataflow bottlenecks prevent optimal data use and value creation. FIG. 16 illustrates a diagram of vehicle 1600 associated with a software-defined, centralized, cloud-native approach for vehicle architectures which may use the disclosed techniques to facilitate a data “freeway” for data use and value creation in-vehicle and in the cloud. The disclosed techniques provide a solution that bridges the gap between the cloud-native ecosystem and a software-defined trend in the in-vehicle platforms to enable connected mobility services wide deployment and scale.

The following is a brief description of in-vehicle applications and the limitation of closed platforms, which can be improved using the disclosed techniques. Applications for in-vehicle platforms are expected to cover a wide range of use cases such as infotainment, maps, maintenance, fleet management, traffic management, smart parking finder, Point-of-presence (POP) services, safe driving, etc. Additional applications may be needed on-demand and per vehicle trajectory/geo-location. These applications are expected to come from different application providers and service providers not necessarily bound to the vehicle original equipment manufacturer (OEM) or Tier1/Tier2 entities. The closed model for the in-vehicle platform, where all SW is provided by the vehicle OEM (working with Tier1/Tier2 entities) will not scale for such a new model of applications and services and will have the following limitations: (i) vehicles dependency and limitations to applications provided by the OEMs, (ii) requirement for OEM maintenance visits to on-board new applications or dependency on over the air update when they take place by the OEM, or (iii) keep depending on a smart phone as a companion device to the vehicle that needs to host all the applications, which is not a practical approach from driver/passenger experience perspective and faces SW limitations if the vehicle does not support car play or the equivalent. The way to scale in-vehicle applications and resolve the mentioned limitations is to have an in-vehicle open platform with a cloud-native agile approach for applications on-boarding and updating (e.g., based on the disclosed techniques).

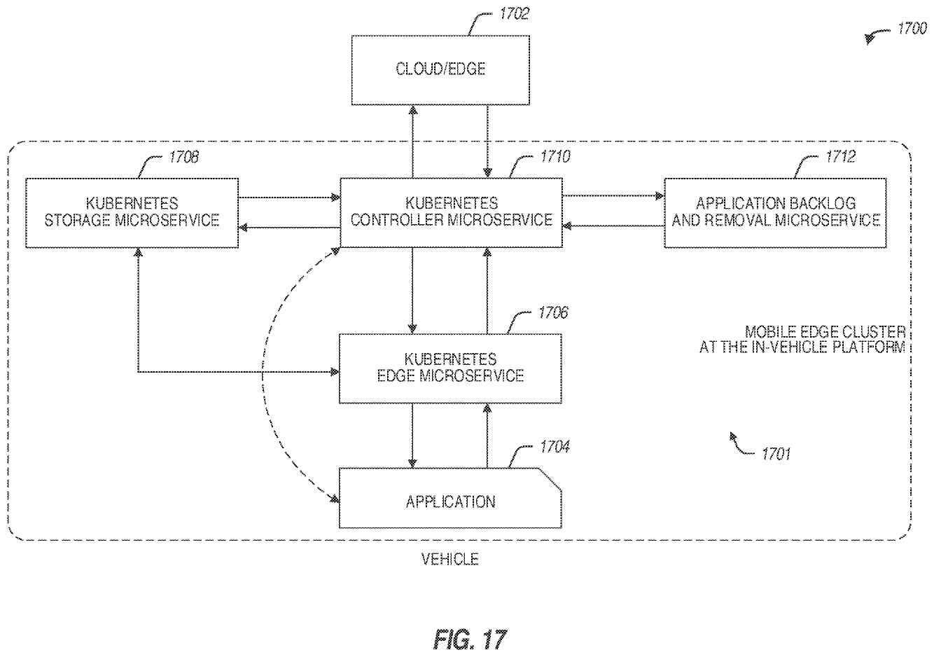

FIG. 17 illustrates a mobile edge cluster at the in-vehicle platform, according to an example embodiment. Referring to FIG. 17, vehicle 1700 may use a mobile edge cluster 1701 providing the disclosed techniques based on a Kubernetes framework.

Kubernetes is a cloud-native software orchestration framework, which may be used as a platform for container scheduling and orchestration. Kubernetes deploys and maintains applications and scales them based on various metrics such as CPU and memory resources, considering compute and storage resources as objects. Most Cloud-native applications are enabled by Kubernetes, which represents a key for the success of edge deployment with services convergence and multi-tenant applications support. In some aspects, a Kubernetes cluster is formed for workload orchestration across multiple edge platforms. The Kubernetes controlling node (also known as a controller or “master node”) is responsible for workload scheduling across worker nodes (also known as edge nodes). In an example Kubernetes framework, the controlling node can be in the Cloud or in another hierarchal edge platform that can be remote or in the same local network as the Kubernetes worker nodes. In some aspects, all nodes (controller and worker nodes) are fixed nodes connected over wired networks.

Referring to FIG. 17, the mobile edge cluster 1701 includes a Kubernetes edge microservice 1706, a Kubernetes storage microservice 1708, a Kubernetes edge controller microservice 1710, and an application backlog and removal microservice 1712.

In some embodiments, the disclosed techniques may be used for providing the following functionalities:
(1) Hybrid storage microservices. The diversity of the applications inside the vehicle 1700 may be associated with different storage needs (e.g., file storage vs. block storage vs. object storage). Such storage needs may depend on the type of applications, type of data for the applications, and application developers/SW vendors' choice, implying hybrid storage needs for the in-vehicle platform. In an example embodiment, the Kubernetes storage microservice 1708 is used, allowing the in-vehicle platforms to have a software storage structure to be deployed on-demand as a pre-requisite for the application 1704 that will be on-boarded. The application orchestrator (at the edge or the Cloud, collectively referred to as Cloud/edge 1702) learns about the in-vehicle platform existing SW storage infrastructure and the application 1704 storage need, then may on-board a storage microservice as a pre-requisite for the application microservice on-boarding and upgrading the storage microservices that match the application (e.g., Amazon S3 compliant storage structure, block storage to help store collected data that needs to be kept for a certain time, etc.).
(2) On-demand Kubernetes cluster formation. In some embodiments, on-demand Kubernetes mobile edge cluster 1701 formation is performed by each vehicle, where the in-vehicle platform has a microservice for Kubernetes mobile cluster that has a dual role: (i) Kubernetes edge node/worker microservice 1706, and (ii) Kubernetes edge controller microservice 1710 to ensure that the controller is reachable even if the vehicle loses connectivity to the cloud. The Kubernetes mobile edge cluster 1701 may be configured/built by a vehicle processor and can be expanded to multiple vehicles using V2X communications (e.g., given additional flexibility to orchestrate microservices across vehicles and have collaborative services). This approach creates a cloud-native mobile edge with several advantages as follows:
(a) Edge platform is close to the sensors/data from the vehicle 1700 and can assist with on-demand services on-boarding (e.g., location-based services);
(b) Leverage network accelerator(s) for integrating into Kubernetes frameworks; and
(c) Ability to manage resources through the affinity of I/O with edge nodes.
(3) Connection to the Cloud/edge 1702 (or the edge). The Kubernetes edge controller microservice 1710 may be configured as the point of contact with the Cloud/edge 1702 (or an edge computing node) for controlling the applications on-boarding and update (e.g., of application 1704).
(4) Application backlog and removal microservice 1712. Some applications are required for a temporary time and specific context (e.g., geo-related applications needed during vehicle travel to a certain place; movie or gaming needed during a trip; etc.). It would not be efficient to keep these types of applications all the time in the in-vehicle platform. The in-vehicle platform (specifically the Kubernetes edge controller microservice 1710 as part of the Kubernetes scheduler policies by the controller) may be configured with a microservice for monitoring microservices consumption frequency and context of use, and destroy microservices or on-boarded applications on-demand.

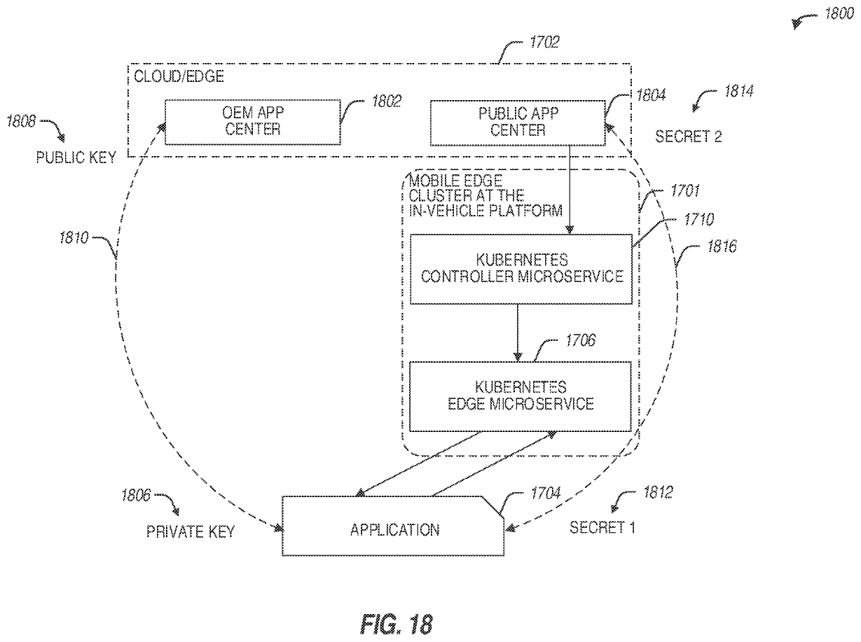

FIG. 18 illustrates a mutual authentication exchange 1800 between a mobile edge cluster 1701 at the in-vehicle platform and an edge infrastructure (e.g., Cloud/edge 1702), according to an example embodiment. Referring to FIG. 18, mutual authentication between the mobile edge cluster at the in-vehicle platform and the application 1704 uses communication paths 1810 and 1816 between the application 1704 and the Cloud/edge 1702.

Given the open platform nature and the application 1704 on-boarding from a cloud-native ecosystem, mutual authentication between the application 1704 and the in-vehicle platform needs to take place. Two approaches can exist using respective communication paths 1810 and 1816.

In a first embodiment, when an OEM controls the application open model through the OEM application center 1802, the vehicle 1700 connects to the OEM cloud through a root of trust authentication mechanism (e.g., a public-private key pair that is stored as a root of trust during the in-vehicle platform manufacturing). The vehicle 1700 then obtains another private-public key pair (e.g., keys 1808 and 1806) on-demand from the OEM application center 1802 when a new application on-boarding is required.

In a second embodiment, a public application center 1804 is used as the application source (e.g., Google marketplace, Apple store, Azure marketplace), where this embodiment excludes safe driving related applications. In this aspect, a multiple-factors authentication technique can be used via communication path 1816. For example, the public app center 1804 sends a secret to the vehicle in real-time (e.g., “secret1” or secret 1812). Vehicle 1700 communicates another secret to the public app center 1804 (e.g., “secret2” or secret 1814) encrypted by “secret1” received by the vehicle. The public app center 1804 then starts sending the app microservice for application 1704 to the Kubernetes edge controller microservice 1710 in the vehicle encrypted with “secret1” and “secret2” and the Kubernetes edge microservice 1706 in the in-vehicle platform.

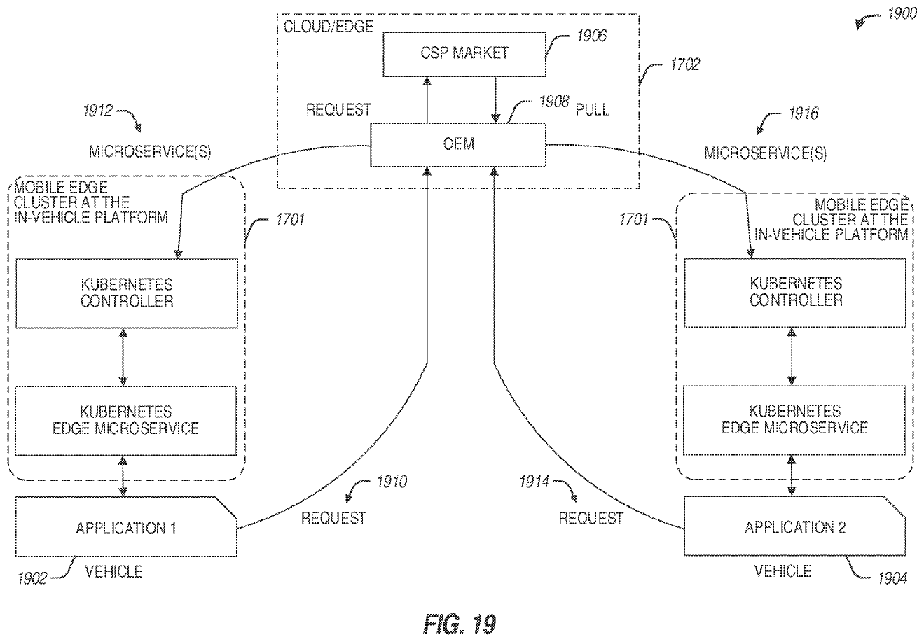

FIG. 19 illustrates a cloud approach 1900 for microservice provisioning between a mobile edge cluster at the in-vehicle platform and an edge infrastructure, according to an example embodiment. Referring to FIG. 19, the disclosed techniques may be used for configuring applications across hybrid clouds in a microservice mesh fashion and get on-boarded to the vehicle.

As an example, the vehicle 1700 can request an additional option to a specific application 1902 (e.g., certain HMI, audio effects, location-based service, etc.), which are horizontal microservices that can serve any application/service. In this case, the OEM cloud 1908 (as part of the Cloud/edge 1702) can have the main service requested (via request 1910) and pulled from the cloud service provider marketplace 1906, and provided as microservice 1912 for application 1902. The horizontal add-ons microservice can be requested via request 1914 and provided as microservice 1916 for application 1904. In some embodiments, the main point of contact with the in-vehicle platform is the OEM cloud 1908, which may connect in the backend with other cloud service provider marketplace(s), that the OEM has a subscription with, to download requested microservices. The OEM cloud 1908 may send to the in-vehicle platform a group of microservices that will be composed by the Kubernetes controller in the in-vehicle platform and on-boarded to the Kubernetes edge node on the in-vehicle platform.

FIG. 20 is a flowchart illustrating a method 2000 for processing messages associated with a messaging service of an edge computing network, according to an example embodiment. Method 2000 includes operations 2002, 2004, 2006, and 2008, which can be performed by, e.g., one or more circuits of a computing node (e.g., computing node 315). The computing node can be a network management node such as an orchestrator, and can be implemented in a vehicle (e.g., vehicle 1700) or outside a vehicle.

At operation 2002, a message from a participating entity of a plurality of participating entities is detected. The message may be received (e.g., by the computing node 315) via a NIC and may be associated with a messaging service of an edge computing network (e.g., edge infrastructure 312). At operation 2004, the message may be mapped to a service class of a plurality of available service classes based on a service request associated with the message. At operation 2006, the message is processed to extract one or more characteristics of the service request. At operation 2008, a digital object representation of the plurality of digital object representations (e.g., digital object representations 322-328) is updated based on the one or more characteristics of the service request. The digital object representation corresponds to the participating entity (which can be one of participating entities 330-336).

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include machine-readable media including read-only memory (ROM), random-access memory (RAM), magnetic disk storage media, optical storage media, flash-memory devices, and other storage devices and media.

A processor subsystem may be used to execute the instruction on the machine-readable media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field-programmable gate array (FPGA), or a fixed-function processor.

Examples, as described herein, may include, or may operate on, logic or a number of components, modules, or mechanisms. Modules may be hardware, software, or firmware communicatively coupled to one or more processors to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. The software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system-on-chip (SoC), desktop computers, laptop computers, tablet computers, servers, smartphones, etc.

As used in any embodiment herein, the term “logic” may refer to firmware and/or circuitry configured to perform any of the aforementioned operations. Firmware may be embodied as code, instructions, or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic, and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

FIG. 21 is a block diagram illustrating a machine in the example form of a computer system 2100, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

The example computer system 2100 includes at least one processor 2102 (e.g., a central processing unit (CPU), a graphics processing unit (GPU) or both, processor cores, compute nodes, etc.), a main memory 2104, and a static memory 2106, which communicate with each other via a link 2108 (e.g., bus). The computer system 2100 may further include a video display unit 2110, an alphanumeric input device 2112 (e.g., a keyboard), and a user interface (UI) navigation device 2114 (e.g., a mouse). In one embodiment, the video display unit 2110, input device 2112, and UI navigation device 2114 are incorporated into a touch screen display. The computer system 2100 may additionally include a storage device 2116 (e.g., a drive unit), a signal generation device 2118 (e.g., a speaker), a network interface device 2120, and one or more sensors 2121, such as a global positioning system (GPS) sensor, compass, accelerometer, gyrometer, magnetometer, or other sensors. The computer system 2100 may include an output controller 2128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some aspects, processor 2102 can include a main processor and a deep learning processor (e.g., used for performing deep learning functions including the neural network processing discussed hereinabove).

The storage device 2116 includes a machine-readable medium 2122 on which is stored one or more sets of data structures and instructions 2124 (e.g., software) embodying or utilized by any one or more of the methodologies or functions described herein. The instructions 2124 may also reside, completely or at least partially, within the main memory 2104, static memory 2106, and/or within the processor 2102 during execution thereof by the computer system 2100, with the main memory 2104, static memory 2106, and the processor 2102 also constituting machine-readable media.

While the machine-readable medium 2122 is illustrated in an example embodiment to be a single medium, the term “machine-readable medium” may include a single medium or multiple media (e.g., a centralized or distributed database, and/or associated caches and servers) that store the one or more instructions 2124. The term “machine-readable medium” shall also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 2124 may further be transmitted or received over a communications network 2126 using one or more antennas 2160 and a transmission medium via the network interface device 2120 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible media to facilitate communication of such software.

It should be understood that the functional units or capabilities described in this specification may have been referred to or labeled as components, circuits, or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

### ADDITIONAL NOTES & EXAMPLES

Example 1 is a computing node in an edge computing network, the node including: a network interface card (NIC); memory (or another type of storage) configured to store a plurality of digital object representations of a corresponding plurality of participating entities in the edge computing network; and processing circuitry coupled to the memory and the NIC, the processing circuitry configured to: detect a message from a participating entity of the plurality of participating entities, the message received via the NIC and associated with a messaging service of the edge computing network; map the message to a service class of a plurality of available service classes based on a service request associated with the message; process the message to extract one or more characteristics of the service request; and update a digital object representation of the plurality of digital object representations based on the one or more characteristics of the service request, the digital object representation corresponding to the participating entity.

In Example 2, the subject matter of Example 1 includes subject matter where the edge computing network includes a transportation-related network with a plurality of sensors, and the processing circuitry is configured to detect the plurality of participating entities via the plurality of sensors.

In Example 3, the subject matter of Examples 1-2 includes subject matter where the plurality of participating entities includes one or more of: a network device, the network device comprising at least one of a base station, a roadside unit (RSU), a vehicle with an in-vehicle platform, and user equipment (UE); a human; and a non-network enabled object.

In Example 4, the subject matter of Examples 2-3 includes subject matter where each digital object representation of the plurality of digital object representations includes one or more of: a geo-location of a corresponding participating entity of the plurality of participating entities; a velocity of the corresponding participating entity; a type of actor in the transportation-related network for the corresponding participating entity; an entity identification (ID) of the corresponding participating entity; a trajectory of estimated movement of the corresponding participating entity; and acceleration or deceleration information for the corresponding participating entity.

In Example 5, the subject matter of Examples 1-4 includes subject matter where the plurality of available service classes includes: an awareness service (AS) class; an on-demand service (ODS) class; and an event-triggered service (ETS) class.

In Example 6, the subject matter of Example 5 includes subject matter where the message is mapped to the AS class, and the processing circuitry is configured to encode a service awareness message for transmission to the participating entity, the service awareness message including a list of services provided within the edge computing network.

In Example 7, the subject matter of Example 6 includes subject matter where the message from the participating entity is a service awareness message response including the service request.

In Example 8, the subject matter of Example 7 includes subject matter where the service request identifies a service of interest from the list of services provided within the edge computing network.

In Example 9, the subject matter of Example 8 includes subject matter where the processing circuitry is configured to: update the digital object representation corresponding to the participating entity with state information associated with consumption of the service of interest by the participating entity.

In Example 10, the subject matter of Examples 5-9 includes subject matter where the message is mapped to the ODS class, the message including the service request, and the service request including an on-demand request and a desired quality of service (QoS) for the on-demand request.

In Example 11, the subject matter of Example 10 includes subject matter where the processing circuitry is configured to retrieve historical data providing a response to the on-demand request, the response complying with the desired QoS; provide the historical data to the participating entity; and update the digital object representation corresponding to the participating entity based on the provided historical data.

In Example 12, the subject matter of Examples 10-11 includes subject matter where the processing circuitry is configured to retrieve real-time data from a real-time data feed within the edge computing network, the retrieved real-time data providing a response to the on-demand request, the response complying with the desired QoS; provide the real-time data to the participating entity; and update the digital object representation corresponding to the participating entity based on the provided real-time data.

In Example 13, the subject matter of Examples 10-12 includes subject matter where the processing circuitry is configured to generate estimated data using a predictive model within the edge computing network, the estimated data providing a response to the on-demand request, the response complying with the desired QoS; provide the estimated data to the participating entity; and update the digital object representation corresponding to the participating entity based on the provided estimated data.

In Example 14, the subject matter of Examples 10-13 includes subject matter where the processing circuitry is configured to retrieve historical data providing a first response to the on-demand request; retrieve real-time data from a real-time data feed within the edge computing network, the retrieved real-time data providing a second response to the on-demand request; generate estimated data using a predictive model within the edge computing network, the estimated data providing a third response to the on-demand request; generate aggregate data based on the historical data, the real-time data, and the estimated data; provide the aggregated data to the participating entity; and update the digital object representation corresponding to the participating entity based on the provided aggregated data, wherein the historical data, the real-time data, and the estimated data comply with the desired QoS.

In Example 15, the subject matter of Examples 5-14 includes subject matter where the message is mapped to the ETS class, and the message includes an event notification message for an event.

In Example 16, the subject matter of Example 15 includes subject matter where the processing circuitry is configured to retrieve historical data with a plurality of prior events and a corresponding plurality of event categories; match the event to a prior event of the plurality of prior events; detect an event category of the plurality of event categories, the event category corresponding to the prior event; and generate a response to the event notification message for communication to the plurality of participating entities in the edge computing network, the response based on the prior event and the event category.

In Example 17, the subject matter of Examples 1-16 includes subject matter where the processing circuitry is configured to detect using monitoring logic of the computing node, a triggering condition associated with at least one of the plurality of participating entities.

In Example 18, the subject matter of Example 17 includes subject matter where the processing circuitry is configured to generate an activation function based on the detected triggering condition, the activation function corresponding to a desired real-time data.

In Example 19, the subject matter of Example 18 includes subject matter where the processing circuitry is configured to: trigger the activation function to register a service of at least a second computing node in the edge computing network, the services mapped to the activation function.

In Example 20, the subject matter of Example 19 includes subject matter where the at least second computing node is configured to stream the desired real-time data as the registered service in response to triggering the activation function.

In Example 21, the subject matter of Examples 1-20 includes subject matter where the participating entity is a vehicle including one or more in-vehicle processors, the one or more in-vehicle processors forming an in-vehicle computing platform executing a plurality of microservices.

In Example 22, the subject matter of Example 21 includes subject matter where the NIC is configured to receive the message from a controller microservice of the plurality of microservices executing via the one or more in-vehicle processors.

In Example 23, the subject matter of Example 22 includes subject matter where the processing circuitry is configured to perform a root of trust authentication exchange with the controller microservice of the plurality of microservices, the root of trust authentication exchange causing authentication of a messaging application executing via the one or more in-vehicle processors, the messaging application generating the message for the messaging service of the edge computing network.

In Example 24, the subject matter of Examples 22-23 includes subject matter where the processing circuitry is configured to perform a multiple-factor authentication exchange with the controller microservice of the plurality of microservices, the multiple-factor authentication exchange causing authentication of a messaging application executing via the one or more in-vehicle processors, the messaging application generating the message for the messaging service of the edge computing network.

In Example 25, the subject matter of Example 24 includes subject matter where the message received from the messaging application includes statistical information associated with the vehicle.

In Example 26, the subject matter of Example 25 includes subject matter where the statistical information originates from a storage microservice of the plurality of microservices executing via the one or more in-vehicle processors forming the in-vehicle computing platform.

Example 27 is at least one machine-readable storage medium including instructions stored thereupon, which when executed by processing circuitry of a computing node in an edge computing network, cause the processing circuitry to perform operations including: detecting a message from a participating entity of a plurality of participating entities of the edge computing network, the message received via a network interface card (NIC) and associated with a messaging service of the edge computing network; mapping the message to a service class of a plurality of available service classes based on a service request associated with the message; processing the message to extract one or more characteristics of the service request; and updating a digital object representation of a plurality of digital object representations of the plurality of participating entities, the updating based on the one or more characteristics of the service request, the digital object representation corresponding to the participating entity.

In Example 28, the subject matter of Example 27 includes subject matter where the edge computing network includes a transportation-related network with a plurality of sensors, and the processing circuitry further performs operations including detecting the plurality of participating entities via the plurality of sensors.

In Example 29, the subject matter of Examples 27-28 includes subject matter where the plurality of participating entities includes one or more of: a network device, the network device comprising at least one of a base station, a roadside unit (RSU), a vehicle with an in-vehicle platform, and user equipment (UE); a human; and a non-network enabled object.

In Example 30, the subject matter of Examples 28-29 includes subject matter where each digital object representation of the plurality of digital object representations includes one or more of: a geo-location of a corresponding participating entity of the plurality of participating entities; a velocity of the corresponding participating entity; a type of actor in the transportation-related network for the corresponding participating entity; an entity identification (ID) of the corresponding participating entity; a trajectory of estimated movement of the corresponding participating entity; and acceleration or deceleration information for the corresponding participating entity.

In Example 31, the subject matter of Examples 27-30 includes subject matter where the plurality of available service classes includes: an awareness service (AS) class; an on-demand service (ODS) class; and an event-triggered service (ETS) class.

In Example 32, the subject matter of Example 31 includes subject matter where the message is mapped to the AS class, and the processing circuitry further performs operations including encoding a service awareness message for transmission to the participating entity, the service awareness message including a list of services provided within the edge computing network.

In Example 33, the subject matter of Example 32 includes subject matter where the message from the participating entity is a service awareness message response including the service request.

In Example 34, the subject matter of Example 33 includes subject matter where the service request identifies a service of interest from the list of services provided within the edge computing network.

In Example 35, the subject matter of Example 34 includes subject matter where the processing circuitry further performs operations including updating the digital object representation corresponding to the participating entity with state information associated with consumption of the service of interest by the participating entity.

In Example 36, the subject matter of Examples 31-35 includes subject matter where the message is mapped to the ODS class, the message including the service request, and the service request including an on-demand request and a desired quality of service (QoS) for the on-demand request.

In Example 37, the subject matter of Example 36 includes subject matter where the processing circuitry further performs operations including retrieving historical data providing a response to the on-demand request, the response complying with the desired QoS; providing the historical data to the participating entity; and updating the digital object representation corresponding to the participating entity based on the provided historical data.

In Example 38, the subject matter of Examples 36-37 includes subject matter where the processing circuitry further performs operations including retrieving real-time data from a real-time data feed within the edge computing network, the retrieved real-time data providing a response to the on-demand request, the response complying with the desired QoS; providing the real-time data to the participating entity; and updating the digital object representation corresponding to the participating entity based on the provided real-time data.

In Example 39, the subject matter of Examples 36-38 includes subject matter where the processing circuitry further performs operations including generating estimated data using a predictive model within the edge computing network, the estimated data providing a response to the on-demand request, the response complying with the desired QoS; providing the estimated data to the participating entity; and updating the digital object representation corresponding to the participating entity based on the provided estimated data.

In Example 40, the subject matter of Examples 36-39 includes subject matter where the processing circuitry further performs operations including retrieving historical data providing a first response to the on-demand request; retrieving real-time data from a real-time data feed within the edge computing network, the retrieved real-time data providing a second response to the on-demand request; generating estimated data using a predictive model within the edge computing network, the estimated data providing a third response to the on-demand request; generating aggregate data based on the historical data, the real-time data, and the estimated data; providing the aggregated data to the participating entity; and updating the digital object representation corresponding to the participating entity based on the provided aggregated data, wherein the historical data, the real-time data, and the estimated data comply with the desired QoS.

In Example 41, the subject matter of Examples 31-40 includes subject matter where the message is mapped to the ETS class, and the message includes an event notification message for an event.

In Example 42, the subject matter of Example 41 includes subject matter where the processing circuitry further performs operations including retrieving historical data with a plurality of prior events and a corresponding plurality of event categories; matching the event to a prior event of the plurality of prior events; detecting an event category of the plurality of event categories, the event category corresponding to the prior event; and generating a response to the event notification message for communication to the plurality of participating entities in the edge computing network, the response based on the prior event and the event category.

In Example 43, the subject matter of Examples 27-42 includes subject matter where the processing circuitry further performs operations including detecting using monitoring logic of the computing node, a triggering condition associated with at least one of the plurality of participating entities.

In Example 44, the subject matter of Example 43 includes subject matter where the processing circuitry further performs operations including generating an activation function based on the detected triggering condition, the activation function corresponding to a desired real-time data.

In Example 45, the subject matter of Example 44 includes subject matter where the processing circuitry further performs operations including triggering the activation function to register an operating system kernel of at least a second computing node in the edge computing network, the operating system kernel mapped to the activation function.

In Example 46, the subject matter of Example 45 includes subject matter where the operating system kernel is configured to stream the desired real-time data in response to triggering the activation function.

In Example 47, the subject matter of Examples 27-46 includes subject matter where the participating entity is a vehicle including one or more in-vehicle processors, the one or more in-vehicle processors forming an in-vehicle computing platform executing a plurality of microservices.

In Example 48, the subject matter of Example 47 includes subject matter where the NIC is configured to receive the message from a controller microservice of the plurality of microservices executing via the one or more in-vehicle processors.

In Example 49, the subject matter of Example 48 includes subject matter where the processing circuitry further performs operations including performing a root of trust authentication exchange with the controller microservice of the plurality of microservices, the root of trust authentication exchange causing authentication of a messaging application executing via the one or more in-vehicle processors, the messaging application generating the message for the messaging service of the edge computing network.

In Example 50, the subject matter of Examples 48-49 includes subject matter where the processing circuitry further performs operations including performing a multiple-factor authentication exchange with the controller microservice of the plurality of microservices, the multiple-factor authentication exchange causing authentication of a messaging application executing via the one or more in-vehicle processors, the messaging application generating the message for the messaging service of the edge computing network.

In Example 51, the subject matter of Example 50 includes subject matter where the message received from the messaging application includes statistical information associated with the vehicle.

In Example 52, the subject matter of Example 51 includes subject matter where the statistical information originates from a storage microservice of the plurality of microservices executing via the one or more in-vehicle processors forming the in-vehicle computing platform.

Example 53 is a computing node in an edge computing network, the computing node including means for detecting a message from a participating entity of a plurality of participating entities of the edge computing network, the message received via a network interface card (NIC), and associated with a messaging service of the edge computing network; means for mapping the message to a service class of a plurality of available service classes based on a service request associated with the message; means for processing the message to extract one or more characteristics of the service request; and means for updating a digital object representation of a plurality of digital object representations of the plurality of participating entities, the updating based on the one or more characteristics of the service request, the digital object representation corresponding to the participating entity.

In Example 54, the subject matter of Example 53 includes subject matter where the edge computing network includes a transportation-related network with a plurality of sensors, and wherein the computing node further includes means for detecting the plurality of participating entities via the plurality of sensors.

In Example 55, the subject matter of Examples 53-54 includes subject matter where the plurality of participating entities includes one or more of: a network device, the network device comprising at least one of a base station, a roadside unit (RSU), a vehicle with an in-vehicle platform, and user equipment (UE); a human; and a non-network enabled object.

In Example 56, the subject matter of Examples 54-55 includes subject matter where each digital object representation of the plurality of digital object representations includes one or more of: a geo-location of a corresponding participating entity of the plurality of participating entities; a velocity of the corresponding participating entity; a type of actor in the transportation-related network for the corresponding participating entity; an entity identification (ID) of the corresponding participating entity; a trajectory of estimated movement of the corresponding participating entity; and acceleration or deceleration information for the corresponding participating entity.

In Example 57, the subject matter of Examples 53-56 includes subject matter where the plurality of available service classes includes: an awareness service (AS) class; an on-demand service (ODS) class; and an event-triggered service (ETS) class.

In Example 58, the subject matter of Example 57 includes subject matter where the message is mapped to the AS class, and the computing node further includes means for encoding a service awareness message for transmission to the participating entity, the service awareness message including a list of services provided within the edge computing network.

In Example 59, the subject matter of Example 58 includes subject matter where the message from the participating entity is a service awareness message response including the service request.

In Example 60, the subject matter of Example 59 includes subject matter where the service request identifies a service of interest from the list of services provided within the edge computing network.

In Example 61, the subject matter of Example 60 includes, means for updating the digital object representation corresponding to the participating entity with state information associated with consumption of the service of interest by the participating entity.

In Example 62, the subject matter of Examples 57-61 includes subject matter where the message is mapped to the ODS class, the message including the service request, and the service request including an on-demand request and a desired quality of service (QoS) for the on-demand request.

In Example 63, the subject matter of Example 62 includes, means for retrieving historical data providing a response to the on-demand request, the response complying with the desired QoS; means for providing the historical data to the participating entity; and means for updating the digital object representation corresponding to the participating entity based on the provided historical data.

In Example 64, the subject matter of Examples 62-63 includes, means for retrieving real-time data from a real-time data feed within the edge computing network, the retrieved real-time data providing a response to the on-demand request, the response complying with the desired QoS; means for providing the real-time data to the participating entity; and means for updating the digital object representation corresponding to the participating entity based on the provided real-time data.

In Example 65, the subject matter of Examples 62-64 includes, means for generating estimated data using a predictive model within the edge computing network, the estimated data providing a response to the on-demand request, the response complying with the desired QoS; means for providing the estimated data to the participating entity; and means for updating the digital object representation corresponding to the participating entity based on the provided estimated data.

In Example 66, the subject matter of Examples 62-65 includes, means for retrieving historical data providing a first response to the on-demand request; means for retrieving real-time data from a real-time data feed within the edge computing network, the retrieved real-time data providing a second response to the on-demand request; means for generating estimated data using a predictive model within the edge computing network, the estimated data providing a third response to the on-demand request; means for generating aggregate data based on the historical data, the real-time data, and the estimated data; means for providing the aggregated data to the participating entity; and means for updating the digital object representation corresponding to the participating entity based on the provided aggregated data, wherein the historical data, the real-time data, and the estimated data comply with the desired QoS.

In Example 67, the subject matter of Examples 57-66 includes subject matter where the message is mapped to the ETS class, and the message includes an event notification message for an event.

In Example 68, the subject matter of Example 67 includes, means for retrieving historical data with a plurality of prior events and a corresponding plurality of event categories; means for matching the event to a prior event of the plurality of prior events; means for detecting an event category of the plurality of event categories, the event category corresponding to the prior event; and means for generating a response to the event notification message for communication to the plurality of participating entities in the edge computing network, the response based on the prior event and the event category.

In Example 69, the subject matter of Examples 53-68 includes, means for detecting using monitoring logic of the computing node, a triggering condition associated with at least one of the plurality of participating entities.

In Example 70, the subject matter of Example 69 includes, means for generating an activation function based on the detected triggering condition, the activation function corresponding to a desired real-time data.

In Example 71, the subject matter of Example 70 includes, means for triggering the activation function to register an operating system kernel of at least a second computing node in the edge computing network, the operating system kernel mapped to the activation function.

In Example 72, the subject matter of Example 71 includes subject matter where the operating system kernel is configured to stream the desired real-time data in response to triggering the activation function.

In Example 73, the subject matter of Examples 53-72 includes subject matter where the participating entity is a vehicle including one or more in-vehicle processors, the one or more in-vehicle processors forming an in-vehicle computing platform executing a plurality of microservices.

In Example 74, the subject matter of Example 73 includes subject matter where the NIC is configured to receive the message from a controller microservice of the plurality of microservices executing via the one or more in-vehicle processors.

In Example 75, the subject matter of Example 74 includes, means for performing a root of trust authentication exchange with the controller microservice of the plurality of microservices, the root of trust authentication exchange causing authentication of a messaging application executing via the one or more in-vehicle processors, the messaging application generating the message for the messaging service of the edge computing network.

In Example 76, the subject matter of Examples 74-75 includes, means for performing a multiple-factor authentication exchange with the controller microservice of the plurality of microservices, the multiple-factor authentication exchange causing authentication of a messaging application executing via the one or more in-vehicle processors, the messaging application generating the message for the messaging service of the edge computing network.

In Example 77, the subject matter of Example 76 includes subject matter where the message received from the messaging application includes statistical information associated with the vehicle.

In Example 78, the subject matter of Example 77 includes subject matter where the statistical information originates from a storage microservice of the plurality of microservices executing via the one or more in-vehicle processors forming the in-vehicle computing platform.

Example 79 is at least one machine-readable medium including instructions that, when executed by processing circuitry, cause the processing circuitry to perform operations to implement any of Examples 1-78.

Example 80 is an apparatus including means to implement any of Examples 1-78.

Example 81 is a system to implement any of Examples 1-78.

Example 82 is a method to implement any of Examples 1-78.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. A computing node in an edge computing network, the computing node comprising:
a network interface card (NIC);
memory configured to store a plurality of digital object representations of a corresponding plurality of participating entities in the edge computing network; and
processing circuitry coupled to the memory and the NIC, the processing circuitry configured to:
detect a message from a participating entity of the plurality of participating entities, the message received via the NIC and associated with a messaging service of the edge computing network;
map the message to a service class of a plurality of available service classes based on a service request associated with the message;
process the message to extract one or more characteristics of the service request; and
update a digital object representation of the plurality of digital object representations based on the one or more characteristics of the service request, the digital object representation corresponding to the participating entity.

27. The computing node of claim 26, wherein the edge computing network comprises a transportation-related network with a plurality of sensors, and the processing circuitry is configured to:
detect the plurality of participating entities via the plurality of sensors.

28. The computing node of claim 26, wherein the plurality of participating entities comprise one or more of:
a network device, the network device comprising at least one of a base station, a roadside unit (RSU), a vehicle with an in-vehicle platform, and user equipment (UE);
a human;
a non-network enabled object.

29. The computing node of claim 27, wherein each digital object representation of the plurality of digital object representations comprises one or more of:
a geo-location of a corresponding participating entity of the plurality of participating entities;
a velocity of the corresponding participating entity;
a type of actor in the transportation-related network for the corresponding participating entity;
an entity identification (ID) of the corresponding participating entity;
a trajectory of estimated movement of the corresponding participating entity; and
acceleration or deceleration information for the corresponding participating entity.

30. The computing node of claim 26, wherein the plurality of available service classes comprises:
an awareness service (AS) class;
an on-demand service (ODS) class; and
an event-triggered service (ETS) class.

31. The computing node of claim 30, wherein the message is mapped to the AS class, and the processing circuitry is configured to:
encode a service awareness message for transmission to the participating entity, the service awareness message including a list of services provided within the edge computing network.

32. The computing node of claim 31, wherein the message from the participating entity is a service awareness message response including the service request.

33. The computing node of claim 32, wherein the service request identifies a service of interest from the list of services provided within the edge computing network.

34. The computing node of claim 33, wherein the processing circuitry is configured to:
update the digital object representation corresponding to the participating entity with state information associated with consumption of the service of interest by the participating entity.

35. The computing node of claim 30, wherein the message is mapped to the ODS class, the message including the service request, and the service request comprising an on-demand request and a desired quality of service (QoS) for the on-demand request.

36. The computing node of claim 35, wherein the processing circuitry is configured to:
retrieve historical data providing a response to the on-demand request, the response complying with the desired QoS;
provide the historical data to the participating entity; and
update the digital object representation corresponding to the participating entity based on the provided historical data.

37. The computing node of claim 35, wherein the processing circuitry is configured to:
retrieve real-time data from a real-time data feed within the edge computing network, the retrieved real-time data providing a response to the on-demand request, the response complying with the desired QoS;
provide the real-time data to the participating entity; and
update the digital object representation corresponding to the participating entity based on the provided real-time data.

38. At least one non-transitory machine-readable storage medium comprising instructions stored thereupon, which when executed by processing circuitry of a computing node in an edge computing network, cause the processing circuitry to perform operations comprising:
detecting a message from a participating entity of a plurality of participating entities of the edge computing network, the message received via a network interface card (NIC) and associated with a messaging service of the edge computing network;
mapping the message to a service class of a plurality of available service classes based on a service request associated with the message;
processing the message to extract one or more characteristics of the service request; and
updating a digital object representation of a plurality of digital object representations of the plurality of participating entities, the updating based on the one or more characteristics of the service request, the digital object representation corresponding to the participating entity.

39. The at least one non-transitory machine-readable storage medium of claim 38, wherein the edge computing network comprises a transportation-related network with a plurality of sensors, and the processing circuitry further performs operations comprising:
detecting the plurality of participating entities via the plurality of sensors.

40. The at least one non-transitory machine-readable storage medium of claim 38, wherein the plurality of participating entities comprises one or more of:
a network device, the network device comprising at least one of a base station, a roadside unit (RSU), a vehicle with an in-vehicle platform, and user equipment (UE);
a human; and
a non-network enabled object.

41. The at least one non-transitory machine-readable storage medium of claim 39, wherein each digital object representation of the plurality of digital object representations comprises one or more of:
a geo-location of a corresponding participating entity of the plurality of participating entities;
a velocity of the corresponding participating entity;
a type of actor in the transportation-related network for the corresponding participating entity;
an entity identification (ID) of the corresponding participating entity;
a trajectory of estimated movement of the corresponding participating entity; and
acceleration or deceleration information for the corresponding participating entity.

42. The at least one non-transitory machine-readable storage medium of claim 39, wherein the plurality of available service classes comprises:
an awareness service (AS) class;
an on-demand service (ODS) class; and
an event-triggered service (ETS) class.

43. The at least one non-transitory machine-readable storage medium of claim 42, wherein the message is mapped to the AS class, and the processing circuitry further performs operations comprising:
encoding a service awareness message for transmission to the participating entity, the service awareness message including a list of services provided within the edge computing network;
wherein the message from the participating entity is a service awareness message response including the service request; and
wherein the service request identifies a service of interest from the list of services provided within the edge computing network.

44. A method comprising:
detecting a message from a participating entity of a plurality of participating entities of an edge computing network, the message received via a network interface card (NIC) of a computing node in the edge computing network and associated with a messaging service of the edge computing network;
mapping the message to a service class of a plurality of available service classes based on a service request associated with the message;
processing the message to extract one or more characteristics of the service request; and
updating a digital object representation of a plurality of digital object representations of the plurality of participating entities, the updating based on the one or more characteristics of the service request, the digital object representation corresponding to the participating entity.

45. The method of claim 44, wherein the edge computing network comprises a transportation-related network with a plurality of sensors, and the method further comprising:
detecting the plurality of participating entities via the plurality of sensors.
